(19) United States
(12) Patent Application Publication
(10) Pub. No.: US 2024/0357402 A1
(43) Pub. Date: Oct. 24, 2024

(54) QUALITY OF EXPERIENCE REPORTING ENHANCEMENTS

(71) Applicant: QUALCOMM Incorporated, San Diego, CA (US)

(72) Inventors: Jianhua LIU, Beijing (CN); Shankar KRISHNAN, San Diego, CA (US); Rajeev KUMAR, San Diego, CA (US); Ozcan OZTURK, San Diego, CA (US); Xipeng ZHU, San Diego, CA (US); Charles Nung LO, San Diego, CA (US)

(21) Appl. No.: 18/685,987

(22) PCT Filed: Oct. 19, 2021
(86) PCT No.: PCT/CN2021/124585

§ 371 Date: Feb. 23, 2024

(51) Int. Cl. H04W 24/10; H04L 41/5067; H04W 28/02

(52) U.S. Cl. CPC H04W 24/10; H04L 41/5067; H04W 28/0268

(57) ABSTRACT

Certain aspects of the present disclosure provide techniques for quality of experience (QoE) reporting in wireless communication networks. An example method performed by a user equipment (UE) includes transmitting a QoE report, including one or more QoE measurements, to a network entity and transmitting, to the network entity, connection identification information associated with the one or more QoE measurements.

### INTRODUCTION

Aspects of the present disclosure relate to wireless communications, and more particularly, to techniques for enhancing quality of experience (QoE) reporting in wireless networks.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication performed by a user equipment (UE). The method includes transmitting a quality of entertainment (QoE) report, including one or more QoE measurements, to a network entity and transmitting, to the network entity, connection identification information associated with the one or more QoE measurements.

One aspect provides a method for wireless communication performed by a network entity. The method includes receiving, from a user equipment (UE), a quality of entertainment (QoE) report, including one or more QoE measurements and receiving, from the UE, connection identification information associated with the one or more QoE measurements.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 is a diagram showing examples for implementing a communications protocol stack 400 in a radio access network (RAN).

FIG. 5 illustrates example operations for reporting quality of experience (QoE) measurements to a wireless network.

FIG. 6 illustrates example operations for RAN-visible QoE measurement.

FIGS. 7 and 8 are call flow diagrams illustrating example operations for identifying a protocol data unit (PDU) session or a quality of service (QOS) flow targeted by one or more QoE measurements in a QoE report.

FIGS. 9 and 10 are call flow diagrams illustrating example operations for identifying a radio bearer targeted by one or more QoE measurements in a QoE report.

FIGS. 11 and 12 are call flow diagrams illustrating example operations for identifying a communication interface targeted by one or more QoE measurements in a QoE report.

FIGS. 13 and 14 are call flow diagrams illustrating example operations for identifying a sidelink interface and an access type targeted by one or more QoE measurements in a QoE report.

FIGS. 15 and 16 are call flow diagrams illustrating example operations for identifying a cell information associated with one or more QoE measurements in a QoE report.

FIG. 17 is a flow diagram illustrating example operations for wireless communication by a user equipment (UE).

FIG. 18 is a flow diagram illustrating example operations for wireless communication by a network entity.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for enhancing quality of experience (QoE) reporting in wireless communication networks. Quality of experience is a measure of the overall acceptability of an application or service as perceived subjectively by an end-user of that application or service. In general, to determine QoE of a particular application or service, an application layer of a UE may perform one or more QoE measurements associated with the application or service and transmit a QoE report to the RAN indicating the one or more QoE measurements.

In some cases, the one or more QoE measurements may target different aspects of a connection associated with the UE, such as one or more protocol data unit (PDU) sessions, one or more quality of service (QOS) flows, one or more radio bearers, one or more communication interfaces, one or more access types, and one or more cells. However, current QoE reports may not distinguish the one or more QoE measurements contained therein with respect to this connection-related information. This presents issues to the network entity as the network entity may need to distinguish which communication interface, which radio bearer, which access type, and so on, the one or more QoE measurements in the QoE report are targeting in order to perform corresponding network configuration optimizations based on the QoE report to improve user experience. Without such information, the network entity may not be able to perform such optimizations and QoE improvement at the UE may be hindered.

Accordingly, aspects of the present disclosure provide techniques for improving QoE reporting in wireless communication networks. For example, in some cases, these techniques may be used to help distinguish connection identification information associated with one or more QoE measurements of a QoE report. More specifically, the techniques presented herein may assist a UE in identifying at least one of a PDU session, a QoS flow, a radio bearer, a communication interface, an access type, or a cell targeted by one or more QoE measurements of a QoE report. The network entity may use this additional connection identification information to perform certain optimizations to improve user experience based on the one or more QoE measurements in the QoE report. For example, in some cases, the network entity may adjust certain configurations associated with the indicated connection identification information (e.g., radio bearer configurations, communication interface configurations, access type configurations, PDU session/QoS flow configurations, cell configurations, etc.) to improve user experience.

### Introduction to Wireless Communication Networks

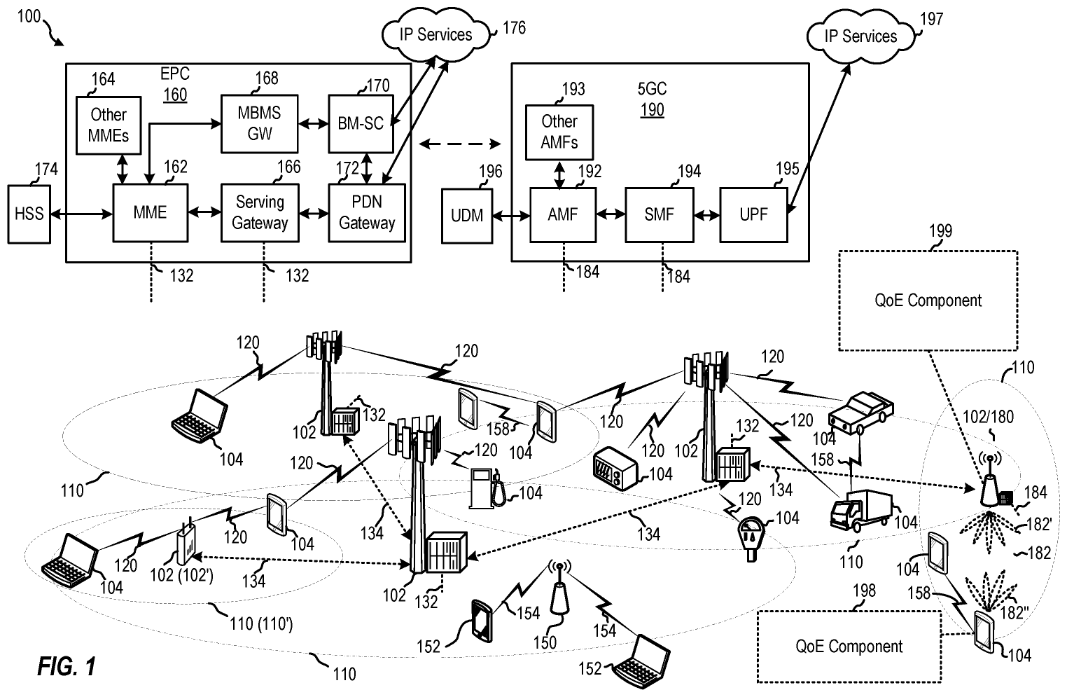

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

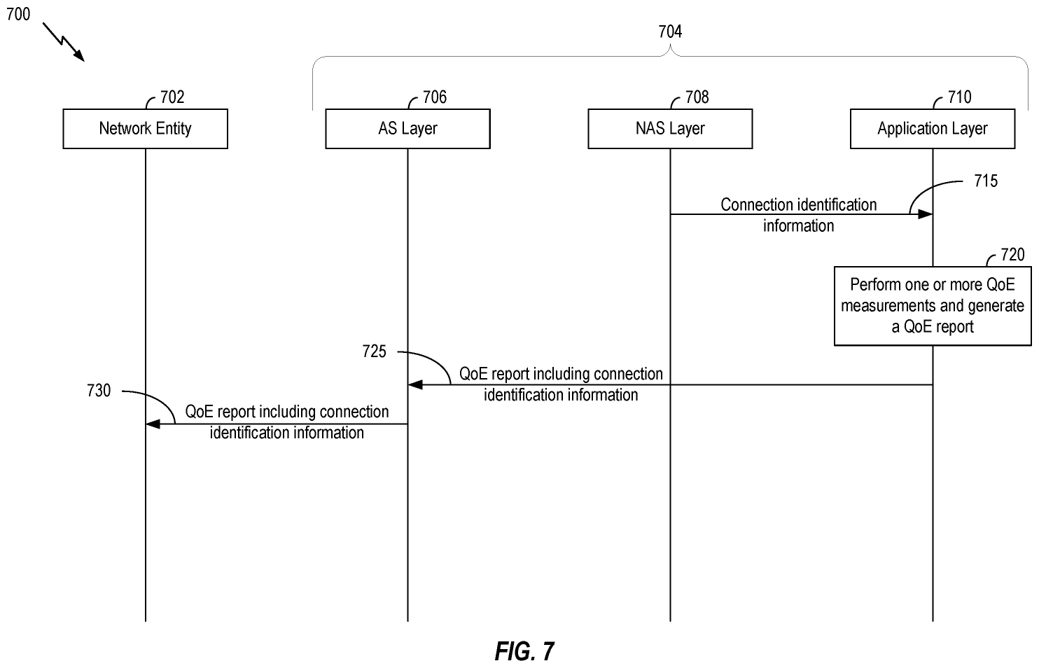

Wireless communication network 100 includes QoE component 199, which may be configured to perform operations illustrated in one or more of FIG. 7-16 or 18, as well as other operations described herein for QoE reporting. Wireless communication network 100 further includes QoE component 198, which may be configured to perform operations illustrated in one or more of FIG. 7-16 or 17, as well as other operations described herein for QoE reporting.

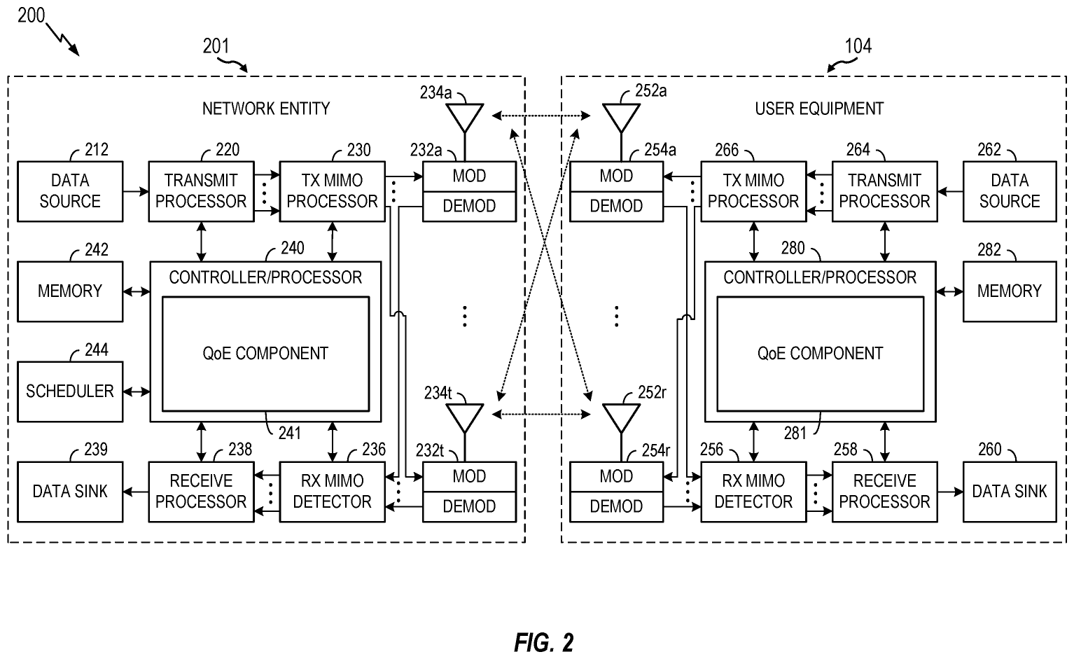

FIG. 2 depicts aspects of an example a network entity 201 and the UE 104. In some cases, the network entity may be an example of the network entity 201 described with respect to FIG. 1 and/or the network entity 702 described with respect to FIGS. 7-16 and 18.

Generally, network entity 201 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, network entity 201 may send and receive data between itself and user equipment 104.

Network entity 201 includes controller/processor 240, which may be configured to implement various functions related to wireless communications. In the depicted example, controller/processor 240 includes QoE component 241, which may be representative of QoE component 199 of FIG. 1. In some cases, QoE component 241 may be configured to perform operations illustrated in one or more of FIG. 7-16 or 18, as well as other operations described herein for QoE reporting. Notably, while depicted as an aspect of controller/processor 240, QoE component 241 may be implemented additionally or alternatively in various other aspects of network entity 201 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes QoE component 281, which may be representative of QoE component 198 of FIG. 1. In some cases, the QoE component 281 is configured to perform operations illustrated in one or more of FIG. 7-16 or 17, as well as other operations described herein for QoE reporting. Notably, while depicted as an aspect of controller/processor 280, QoE component 281 may be implemented additionally or alternatively in various other aspects of user equipment 104 in other implementations.

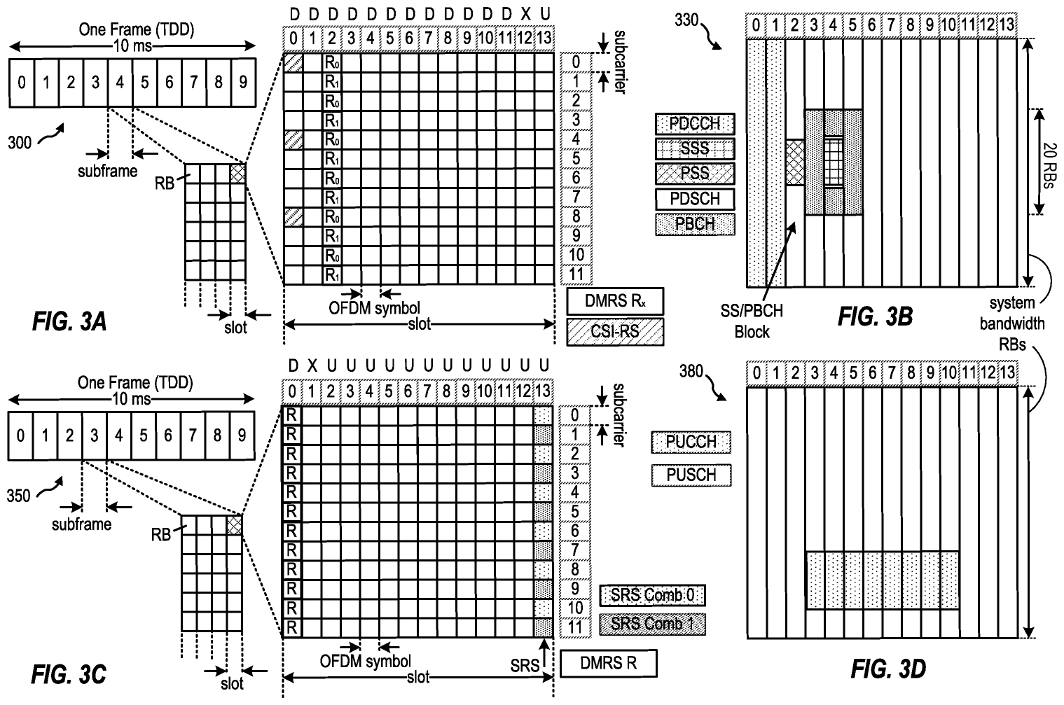

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Example Protocol Stack

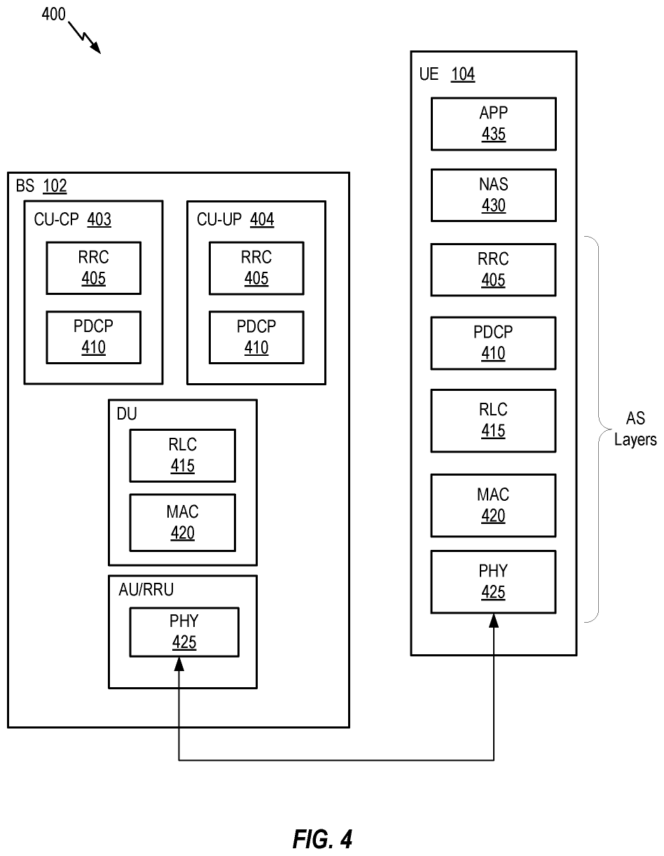

FIG. 4 is a diagram showing examples for implementing a communications protocol stack 400 in a radio access network (RAN), according to aspects of the present disclosure. The illustrated communications protocol stack 400 may be implemented by devices operating in a wireless communication system, such as a 5G NR system (e.g., the wireless communication network 100 of FIG. 1). In various examples, the layers of the protocol stack 400 may be implemented as separate modules of software, portions of a processor or application-specific integrated circuit (ASIC), portions of non-collocated devices connected by a communications link, or various combinations thereof. Collocated and non-collocated implementations may be used, for example, in a protocol stack for a network access device or a UE. As shown in FIG. 4, the system may support various services over one or more protocols. One or more protocol layers of the protocol stack 400 may be implemented by the BS 102 and/or the UE 104.

As shown in FIG. 4, the protocol stack 400 is split in the BS 102. The radio resource control (RRC) layer 405, packet data convergence protocol (PDCP) layer 410, radio link control (RLC) layer 415, media access control (MAC) layer 420, and physical (PHY) layer 425 may be implemented by the BS 102.

An RRC layer controls various RRC protocol functions such as control of RRC connection, control of handover, measurement reporting, etc. The RLC layer is responsible for transfer of upper layer protocol data units, error correction, concatenation, segmentation and reassembly of RLC service data units (SDUs). The MAC layer performs scheduling of data on carriers. The PHY layer provides a means for transmitting of bits over a physical data link on the carriers.

A central unit-control plane (CU-CP) 403 and a central unit-user plane (CU-UP) 404 each may implement the RRC layer 405 and the PDCP layer 410. A distributed unit (DU) may implement the RLC layer 415 and MAC layer 420. The Antenna/Remote Radio Units (AU/RRU) may implement the PHY layer(s) 425. The PHY layers 425 may include a high PHY layer and a low PHY layer.

As shown, the UE 104 may implement the entire protocol stack 400, such as the RRC layer 405, the PDCP layer 410, the RLC layer 415, the MAC layer 420, and the PHY layer(s) 425. In some cases, the RRC layer 405, the PDCP layer 410, the RLC layer 415, the MAC layer 420, and the PHY layer(s) 425 may be part of different access stratum (AS) layers of the UE 104. For example, in some cases, the PHY layer 425 of the UE 104 may be part of a first AS layer (e.g., Layer 1) of the UE 104. As shown, the PHY layers 425 of the BS 102 and UE 104 may facilitate wireless communication between the BS 102 and UE 104. Additionally, the PDCP layer 410, the RLC layer 415, and the MAC layer 420 of the UE 104 may be part of a second AL layer (e.g., Layer 2) of the UE 104, and the RRC layer 405 may be part of a third AS layer (e.g., Layer 3) of the UE 104. Further, as shown, the UE 104 may include or implement a non-access stratum (NAS) layer 430 and an application (APP) layer 435.

In some cases, the NAS layer 430, the RRC layer 405, the PDCP layer 410, the RLC layer 415, the MAC layer 420, the PHY layer 425 of the UE 104 may be implemented in a control plane of the UE 104 while the application layer 435 may be implemented in a user plane of the UE 104. Generally, control-relevant information is exchanged between the BS 102 and the UE 104 within the control plane while user data may be exchanged between the BS 102 and the UE 104 in the user plane.

### Aspects Related to Quality of Experience Reporting Enhancements

In some cases, a user equipment (e.g., UE 104) may communicate with a base station (e.g., BS 102) of a radio access network (RAN) (e.g., wireless communications network 100) over one or more radio bearers, which can each have specified quality-of-service (QOS) or similar properties. As load at the RAN increases, the RAN may become congested, and a quality of experience (QoE) at a UE may decrease, though related services at the UE still meet the QoS of the related radio bearer. In some cases, QoE degradation may manifest in perceived delay in web browsing, file download, call setup, etc. on the UE, choppy video or audio streaming (or decreased quality thereof), and/or the like.

Quality of experience is a measure of the overall acceptability of an application or service as perceived subjectively by an end-user of that application or service. In general, to determine QoE of a particular application or service, the UE may perform one or more QoE measurements associated with the application or service and transmit a QoE report to the RAN indicating the one or more QoE measurements.

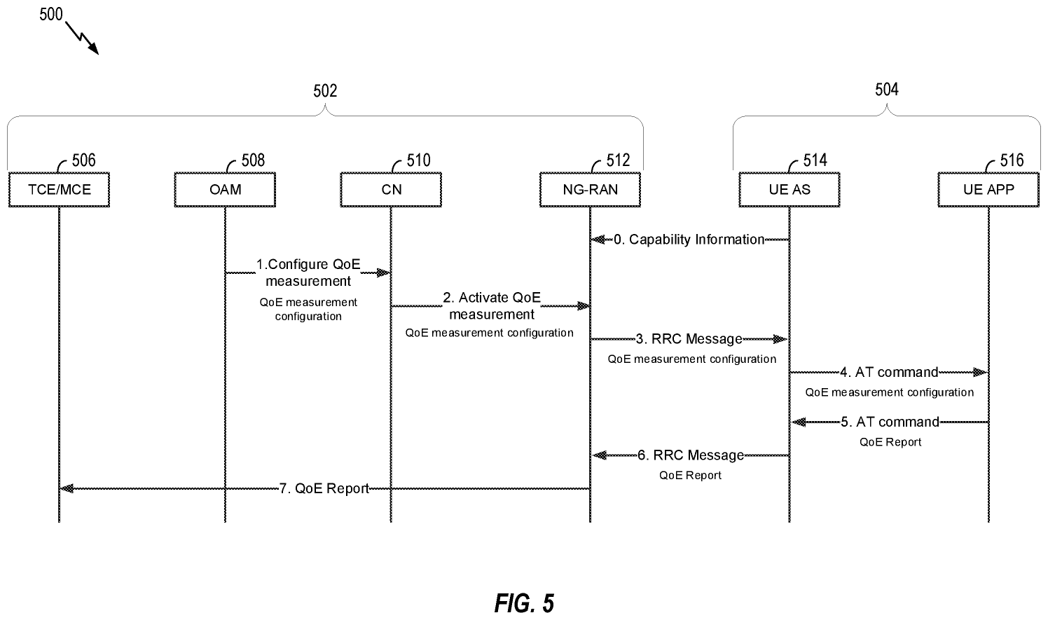

FIG. 5 illustrates example operations 500 for reporting QoE measurements to a wireless network. As shown, the operations 500 may be performed by different network entities within a wireless network 502 as well as different protocol stack layers within a UE 504. For example, as shown, the different network entities of the wireless network 502 may include a trace collection entity (TCE) or measurement collection entity (MCE) 506, an operations administration and maintenance (OAM) entity 508, a core network (CN) 510, and a next generation RAN (NG-RAN) node 512. Additionally, as shown, the different protocol stack layers of the UE 504 may include an access stratum (AS) layer 514 and an application layer 516. In some cases, the UE 504 may be an example of the UE 104 illustrated in FIG. 1 and FIG. 2. Additionally, in some cases, the NG-RAN node 512 may be an example of the BS 102 illustrated in FIG. 1 and FIG. 2.

As shown at step 1 in FIG. 5, QoE reporting may begin with the OAM entity 508 sending a QoE measurement configuration to the CN 510. In some cases, the QoE measurement configuration may be encapsulated by the OAM entity 508 in a transparent container. Additionally, whether the OAM entity 508 configures QoE reporting for the UE 504 may depend on whether the UE 504 supports QoE reporting. Accordingly, in some cases, as shown at step 0 in FIG. 5, the UE 504 may transmit capability information to the NG-RAN node 512 indicating a capability of the UE 504 to perform QoE reporting.

As shown at step 2 in FIG. 5, after receiving the QoE measurement configuration, the CN 510 may initiate activation of QoE measurement configured by the OAM entity 508 and sends the QoE measurement configuration to the NG-RAN node 512. The NG-RAN node 512 may then send the QoE measurement configuration to the AS layer 514 of the UE 504 in radio resource control (RRC) signaling, as shown at step 3. Thereafter, at step 4, the AS layer 514 may forward the QoE measurement configuration to application layer 516 of the UE 504. In some cases, the AS layer 514 may forward the QoE measurement configuration to the AS layer 514 in an attention (AT) command.

The application layer 516 may then perform one or more QoE measurements and generate a QoE report, including the one or more QoE measurements. In some cases, the one or more QoE measurements may correspond to different QoE metrics depending on the particular application or service for which the QoE reporting is configured. For example, in some cases, for a Multimedia Telephony Service for IMS (MTSI) service, the one or more measurements may relate to a corruption duration metric, a successive loss of RTP packets, a frame rate, a jitter duration, a sync loss duration, a round trip time, an average codec bitrate, and codec information. Additional details regarding these QoE measurements and metrics may be found in 3rd Generation Partnership Project (3GPP) technical specification (TS) 26.114 version 16.11.0 section 16. Additionally, details regarding QoE measurements and metrics for a Dynamic Adaptive Streaming over Hypertext Transfer Protocol (DASH) service may be found in 3GPP TS 26.247 version 16.5.0 section 10.2.

In some cases, configuration and reporting for multiple simultaneous QoE measurements for a UE may be supported. After generating the QoE report, the application layer 516 may encapsulate the QoE report in a transparent container and sends the QoE report to the AS layer 514 in another AT command as shown at step 5 in FIG. 5. Thereafter, as shown at step 6, the AS layer 514 sends the QoE report to the NG-RAN node 512 via a separate signaling radio bearer (SRB) (e.g., separate from current SRBs), as this reporting is lower priority than other SRB transmissions. The NG-RAN node 512 then transmits the QoE report to the TCE/MCE 506, as shown at step 7 in FIG. 5.

As noted above, the measurement configuration for the application layer 516, received by the NG-RAN node 512 from OAM entity 508 or CN 510, is encapsulated in a transparent container, which is forwarded to the UE 504 in a downlink RRC message. Similarly, the QoE report received from the application layer 516 of the UE 504 is encapsulated in a transparent container and sent to the NG-RAN node 512 in an uplink RRC message. As such, the NG-RAN node 512 not be able to understand or make use of the one or more QoE measurements in the QoE report as the QoE report is sent inside a transparent container and intended to be processed by the TCE/MCE 506 in the wireless network 502. This type of QoE reporting may be known as “regular” QoE.

Accordingly, another type of QoE reporting involves RAN-visible QoE measurements. For example, in some cases, RAN-visible QoE measurement may be configured by the NG-RAN node 512 node using RRC information elements (IEs). These RRC IEs may include a subset of QoE metrics or measurements that are reported from the UE. UE application layer generate RAN visible measurements and deliver to RRC layer. RAN visible QoE measurement also allows to introduce a set of QoE values. Both QoE metrics and QoE values could be utilized by the NG-RAN node for optimization. RAN visible QoE measurements are supported for the DASH streaming and VR services.

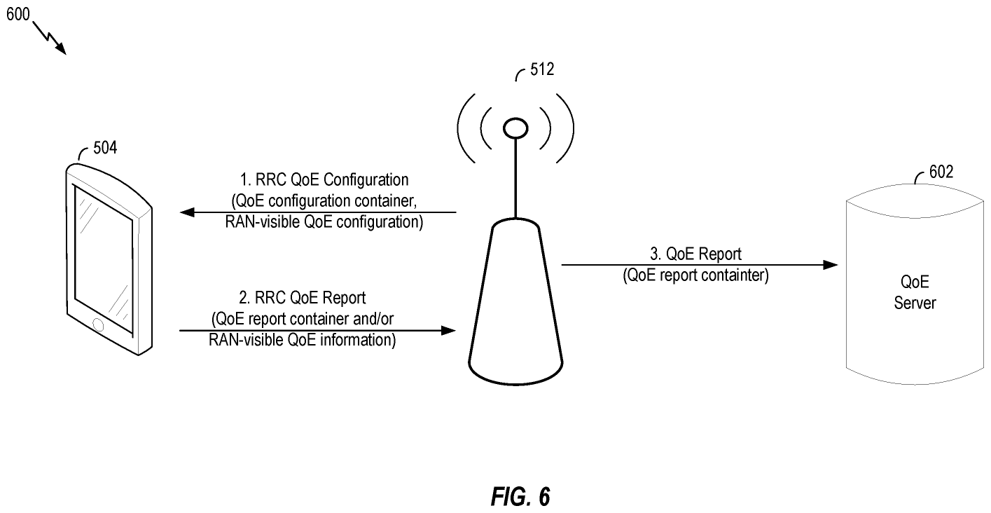

FIG. 6 illustrates example operations 600 for RAN-visible QoE measurement. As shown, the operations 600 may be performed by the UE 504 and the NG-RAN node 512. As shown, at step 1 in FIG. 6, the NG-RAN node 512 assembles and sends the RAN-visible QoE configuration to the UE 504, which may be sent along with the QoE measurement configuration container transmitted from the OAM entity 508, directly or via the CN 510.

Thereafter, the UE 504 receives and applies the RAN-visible QoE configuration and/or QoE measurement configuration container. The RAN-visible QoE configuration may configure the UE 504 to report RAN-visible QoE information comprising a unique value or a combination of values reflecting QoE metrics useful for the NG-RAN node (e.g., buffer level). Based on the RAN-visible configuration, an application layer of the UE 504 (e.g., application layer 516) may generate a RAN-visible QoE report. The RAN-visible QoE report may be provided from the application layer of the UE 504 to an RRC layer of the UE 504 by means of an AT command. The RRC layer may then include the RAN-visible QoE report, along with the QoE report container (e.g., as a separate IE), in an application layer measurement report IE (e.g., MeasReportAppLayer IE), and sends it to the NG-RAN node 512, as shown at step 2 in FIG. 6.

Thereafter, the NG-RAN node 512 processes RAN-visible QoE information within the RAN-visible report and/or forwards a QoE report container to a QoE server 602. Alternatively, in some cases, the OAM entity 508 may generate the RAN-visible QoE report and may send it to the NG-RAN node 512. The NG-RAN node 512 may use the RAN-visible QoE report for various types of network configuration optimizations. For example, in some cases, based on the QoE report, the NG-RAN node 512 may be able to allocate additional radio resources to the UE 504, more quickly schedule the UE, or improve a reliability configuration.

While the techniques described above generally explain how QoE reporting may be performed, these techniques may be associated with certain drawbacks or issues. For example, in cases involving multi-radio access technology dual connectivity (MR-DC) (e.g., in which a UE communicates via different interfaces), the wireless network (e.g., NG-RAN node) may need to distinguish which interface (e.g., master node (MN) interface, secondary node (SN) interface, or sidelink interface (e.g., PC5 interface)) the one or more QoE measurements in the QoE report are targeting in order to perform corresponding network configuration optimizations based on the QoE report. In order to provide information related to the interface targeted by the one or more QoE measurements, the UE may need to determine the interface information for each QoE report or each QoE measurement. However, the one or more QoE measurements and QoE report generation are performed by the application layer of the UE, which may not be aware of the interface information. As such, it is unclear how the interface information associated with the QoE report may be determined by the application layer of the UE and provided to the wireless network.

Additionally, for multi-RAT cases, the wireless network may need to distinguish which an access type the one or more QoE measurements in the QoE report is targeting in order to perform corresponding network configuration optimizations based on the QoE report. As such, the UE may need to determine the access type information for each QoE report or each QoE measurement. However, as noted, the one or more QoE measurements and QoE report generation are performed by the application layer of the UE, which may not be aware of the access type information. As such, it is unclear how the access type information associated with to the QoE report may be determined by the application layer of the UE and provided to the wireless network.

Additionally, in order for the wireless network to have finer network configuration optimization, QoE measurements may be performed targeting a particular protocol data unit (PDU) session or radio bearer. However, again, since the one or more QoE measurements are performed in the application layer of the UE, which may not be aware of the PDU session or radio bearer, it is unclear how the UE can distinguish the PDU session and bearer information for each QoE measurement in the QoE report. Additionally, for QoE measurements while the UE is in an idle or inactive state, the wireless network may need to know the cell that the one or more QoE measurements are targeting. However, the application layer of the UE may not be aware of this cell information and, thus, it is unclear how the UE can distinguish the cell information for each QoE measurement in the QoE report.

Accordingly, aspects of the present disclosure provide techniques for improving QoE reporting in wireless networks. For example, in some cases, these techniques may be used to help distinguish connection identification information associated with one or more QoE measurements of a QoE report. More specifically, the techniques presented herein may assist a UE in identifying at least one of a PDU session, a quality of service (QOS) flow, a radio bearer, a communication interface, an access type, or a cell targeted by the one or more QoE measurements of the QoE report.

For example, in some cases, this connection identification information may be provided to an application layer of the UE, which may include this connection identification information within the QoE report. The application layer may then send the QoE report, including the connection identification information, to a network entity, such as a base station (e.g., BS 102 of FIG. 1 and FIG. 2, NG-RAN node 512, etc.) or an OAM entity (OAM entity 508). In other cases, the application layer may provide the QoE report to another layer of the UE, such as an AS layer, which may then send the QoE report to the network entity along with (but separately from) the connection identification information. Accordingly, in response to receiving the QoE report and associated connection identification information, the network entity may be able to perform certain optimizations to improve user experience. For example, in some cases, the network entity may adjust certain configurations associated with the indicated connection identification information (e.g., radio bearer configurations, communication interface configurations, access type configurations, PDU session/QoS flow configurations, cell configuration, etc.) to improve user experience.

### Example Call Flows Illustrating Operations for Identifying a PDU Session and or a QoS Flow Targeted by QoE Measurements

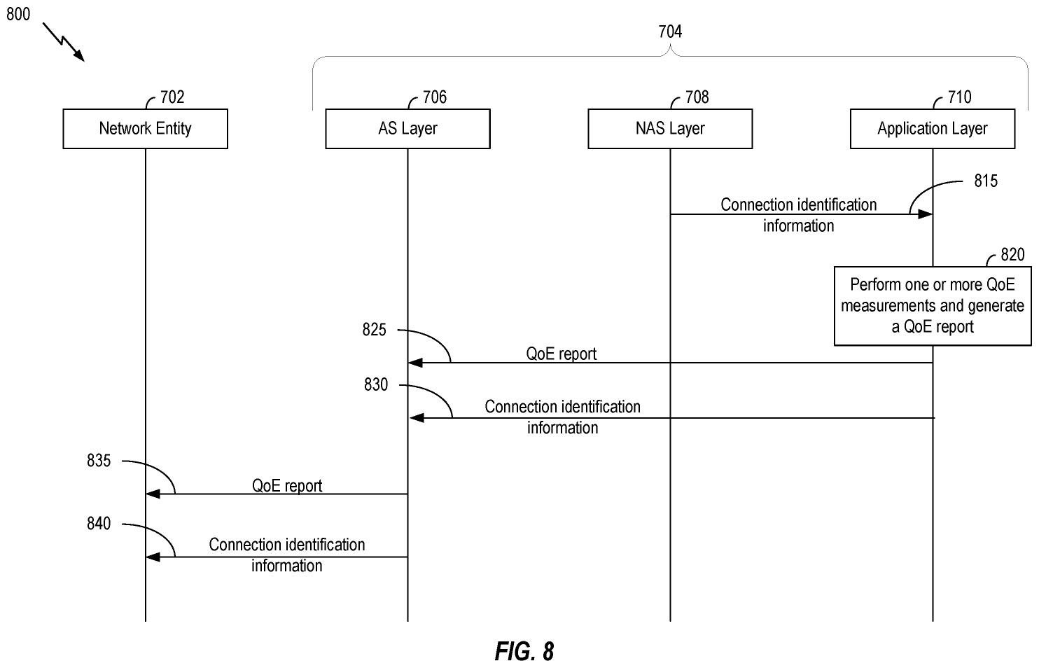

FIGS. 7 and 8 are call flow diagrams illustrating example operations 700 and 800, respectively, for identifying a PDU session or a QoS flow targeted by one or more QoE measurements in a QoE report. As shown, the operations 700 and 800 may be performed by a network entity 702 and one or more protocol stack layers of a UE 704, such as an AS layer 706, a NAS layer 708, and/or an application layer 710. In some cases, the network entity 702 may be an example of the BS 102 illustrated in FIGS. 1 and 2, the NG-RAN node 512 illustrated in FIGS. 5 and 6, or the OAM entity 508 illustrated in FIG. 5. Additionally, in some cases, the UE 704 may be an example of the UE 104 illustrated in FIGS. 1 and 2 and/or the UE 504 illustrated in FIGS. 5 and 6. Further, in some cases, the NAS layer 708 may be an example of the NAS layer 430 of the UE 104 illustrated in FIG. 4. The application layer 710 may be an example of the APP layer 435 of the UE 104 illustrated in FIG. 4. Additionally, in some cases, the AS layer 706 may include a plurality of layers (e.g., the RRC layer 405, the PDCP layer 410, the RLC layer 415, the MAC layer 420, and/or the PHY layer 425 of the UE 104 illustrated in FIG. 4).

FIG. 7 illustrates techniques for providing an indication of one or more Qos flow identifiers (IDs) and/or one or more PDU session IDs to an application layer 710 of the UE 104. The application layer 710 may then include connection identification information (e.g., including an indication of the one or more PDU session IDs and/or one or more QoS flow IDs) within the QoE report sent to the network entity 702.

Accordingly, for example, as shown in FIG. 7, operations 700 begin at 715 with the application layer 710 of the UE 704 receiving an indication of one or more PDU session IDs associated with the UE. As shown, the indication of the one or more PDU session IDs may be received by the application layer 710 from the NAS layer 708, which may be aware of this information. Thereafter, as illustrated at 720, the UE 704 may perform one or QoE measurements and generate a QoE report including the one or more QoE measurements. In some cases, the one or more QoE measurements may target one or more PDU sessions identified by the one or more PDU session IDs received from the NAS layer 708. In some cases, the one or more QoE measurements may comprise “regular” (e.g., non-RAN visible) QoE measurements or RAN-visible QoE measurements.

In some cases, the application layer 710 may be associated with or include a plurality of PDU sessions. In such cases, when there are multiple PDU sessions in the application layer 710, the application layer 710 may use the PDU Session IDs associated with service flows for which the QoE measurement is performed. In other words, assuming the application layer 710 includes a plurality of PDU sessions, when performing the one or more QoE measurements and generating the QoE report, the application layer 710 may use only the PDU Session IDs associated with the service flows for which the one or more QoE measurements are to be performed. Accordingly, for example, in some cases, the one or more QoE measurements may be associated with a subset of PDU sessions of the plurality of PDU session. In such cases, the one or more PDU session IDs included within the connection identification information may include a set of PDU session IDs and each different PDU session ID within the set of PDU session IDs corresponds a different PDU session in the subset of PDU sessions.

In some cases, the application layer 710 may also receive at 715 an indication of one or more QoS flow IDs associated with the UE 704. As noted above, the connection identification information may be received by the application layer 710 from the NAS layer 708, which may be aware of the one or more QoS flow IDs. In some cases, the one or more QoE measurements performed in block 720 of FIG. 7A may target the QoS flow identified by the one or more QoS flow IDs received from the NAS layer 708.

In some cases, a PDU session for which the one or more QoE measurements are performed may be associated with or include a plurality of QoS flows. In such cases, when there are a plurality of QoS flows within a PDU session of the application layer 710, the application layer 710 uses the QoS flows associated with the service flows for which the one or more QoE measurements are performed. In other words, assuming the application layer 710 includes a first PDU session and the first PDU session includes a plurality of QoS flows, when performing the one or more QoE measurements and generating the QoE report, the application layer 710 may use only the QoS flow IDs associated with the service flows for which the one or more QoE measurements are to be performed. Accordingly, for example, in some cases, the one or more QoE measurements are associated with a subset of QoS flows of the plurality of QoS flows. In such cases, the one or more QoS flow IDs included within the connection identification information include a set of QoS flow IDs and each different QoS flow ID within the set of QoS flow IDs corresponds a different QoS flow in the subset of QoS flows.

As shown at 725, the application layer 710 may send the QoE report generated in block 720 to the AS layer 706. In some cases, because the application layer 710 has received the indication of the one or more PDU session IDs and/or the one or more QoS flow IDs from the NAS layer 708, the application layer 710 may include connection identification information associated with the one or more QoE measurements (e.g., including the indication of the one or more PDU session IDs and/or the one or more QoS flow IDs) within the QoE report sent to the AS layer 706. Thereafter, as illustrated at 730, the UE 704 transmits the QoE report, including one or more QoE measurements, and the connection identification information associated with the one or more QoE measurements to the network entity 702. In some cases, transmitting the connection identification information to the network entity 702 comprises transmitting the one or more PDU session IDs within the QoE report, indicating the one or more QoE measurements in the QoE report are associated with one or more PDU sessions identified by the one or more PDU session IDs. Additionally, in some cases, transmitting the connection identification information to the network entity 702 comprises transmitting the one or more QoS flow IDs within the QoE report, indicating the one or more QoE measurements in the QoE report are associated with one or more QoS flows identified by the one or more QoS flow IDs.

As noted above, in some cases, the network entity 702 may include an NG-RAN node (e.g., BS 102). In such cases, in response to receiving the QoE report and included connection identification information, the network entity 702 may derive communication interface information or bearer information associated with the one or more QoE measurements in the QoE report according to the at least one of the one or more PDU session IDs or the one or more QoS flow IDs. The network entity 702 may then forward the communication interface information and/or radio bearer information to an OAM entity (e.g., OAM entity 508) together with the one or more QoE measurements in the QoE report. In some cases, the NG-RAN node and/or the OAM entity may receive the communication interface information and/or radio bearer information and be able to adjust a corresponding configuration associated with the UE 704 to improve service/experience for the UE 704.

FIG. 8 illustrates techniques in which the application layer 710 of the UE 704 provides the QoE report and connection identification information to another layer of the UE 704, such as the AS layer 706. The AS layer 706 may then separately send the QoE report and the connection identification information (e.g., QoS flow ID and/or PDU session ID) to the network entity.

For example, as shown, operations 800 begin at 815 with the application layer 710 of the UE 704 receiving from the NAS layer 708 an indication of one or more PDU session IDs and/or one or more QoS flow IDs. Thereafter, as illustrated at 820, the UE 704 performs one or QoE measurements and generate a QoE report including the one or more QoE measurements. In some cases, the one or more QoE measurements may target one or more PDU sessions identified by the one or more PDU session IDs received from the NAS layer 708 and/or one or more QoS flows identified by the one or more QoS flow IDs received from the NAS layer 708. In general, the operations 815 and 820 may be substantially similar to operations 715 and 720 illustrated in FIG. 7. In some cases, the one or more QoE measurements may comprise “regular” (e.g., non-RAN visible) QoE measurements or RAN-visible QoE measurements.

Thereafter, as shown at 825, the application layer 710 may send the QoE report generated in block 720 to the AS layer 706. Additionally, at 830, the application layer 710 sends connection identification information associated with the one or more QoE measurements (e.g., including at least one of the one or more PDU session IDs or the one or more QoS flow IDs) to the AS layer 706 separately from the QoE report (e.g., not included within the QoE report). Thereafter, as illustrated at 835, transmits the QoE report, including one or more QoE measurements, to the network entity 702. As shown, transmitting the QoE report to the network entity comprises transmitting the QoE report to the network entity 702 from the AS layer 706 of the UE 704.

Additionally, as shown at 840, the UE 704 transmits, to the network entity 702, the connection identification information associated with the one or more QoE measurements. In some cases, transmitting the connection identification information to the network entity 702 comprises transmitting, from the AS layer 706 of the UE 704, the one or more PDU session IDs to the network entity 702 separately from the QoE report. In some cases, the connection identification information indicates that the one or more QoE measurements in the QoE report are associated with one or more PDU sessions identified by the one or more PDU session IDs. In some cases, transmitting the connection identification information to the network entity 702 further comprises transmitting, from the AS layer 706 of the UE 704, the one or more QoS flow IDs to the network entity 702 separately from the QoE report. In some cases, the connection identification information indicates that the one or more QoE measurements in the QoE report are associated with one or more QoS flows identified by the one or more QoS flow IDs.

As noted above, in some cases, the network entity 702 may include an NG-RAN node (e.g., BS 102). In such cases, in response to receiving the QoE report and the connection identification information, the network entity 702 may derive communication interface information or bearer information associated with the one or more QoE measurements in the QoE report according to the at least one of the one or more PDU session IDs or the one or more QoS flow IDs. The network entity 702 may then forward the communication interface information and/or radio bearer information to an OAM entity (e.g., OAM entity 508) together with the one or more QoE measurements in the QoE report.

### Example Call Flows Illustrating Operations for Identifying a Radio Bearer Targeted by QoE Measurements

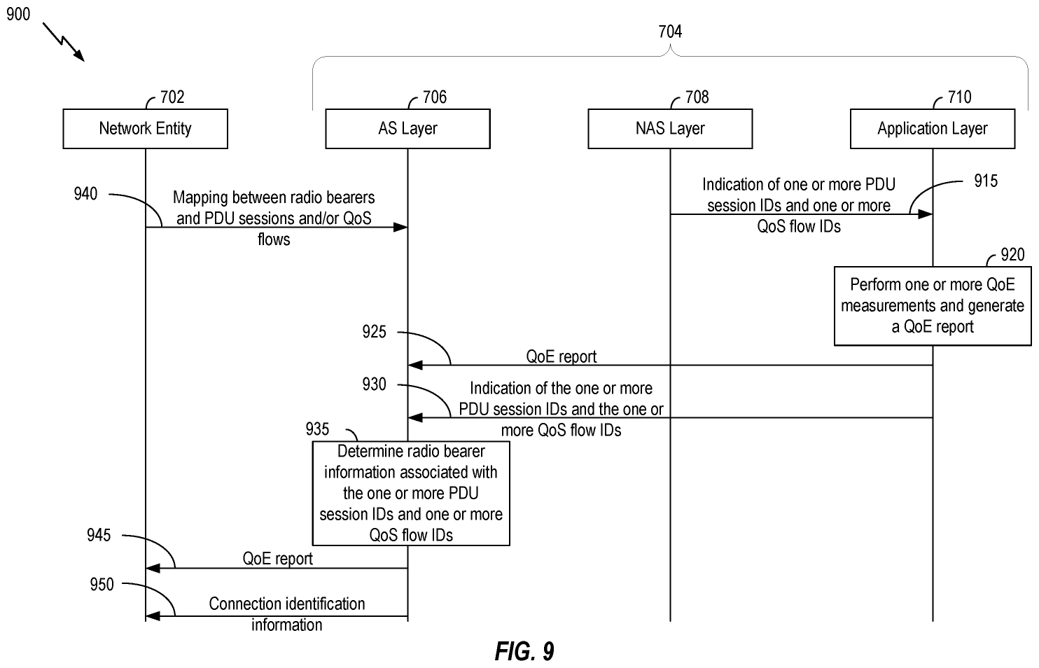

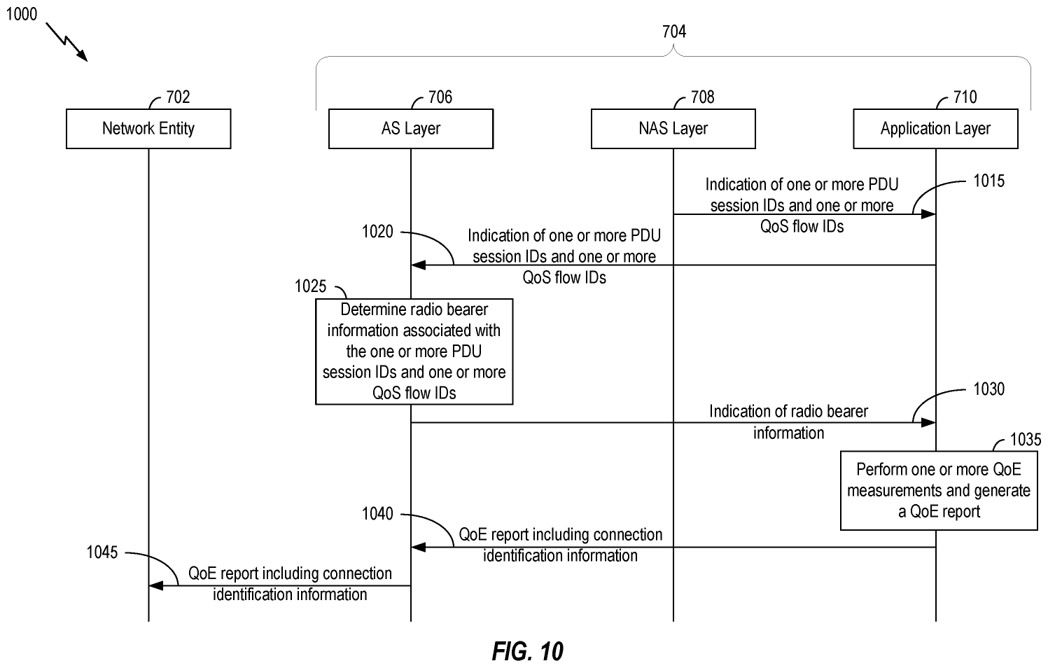

FIGS. 9 and 10 are call flow diagrams illustrating example operations 900 and 1000, respectively, for identifying a radio bearer targeted by one or more QoE measurements in a QoE report. As shown, the operations 900 and 1000 may be performed by the network entity 702 and one or more protocol stack layers of the UE 704, such as the AS layer 706, the NAS layer 708, and/or the application layer 710.

FIG. 9 illustrates techniques in which the application layer 710 of the UE 704 provides the QoE report to the AS layer 706 of the UE 704 and the AS layer 706 separately sends the QoE report and connection identification information (e.g., radio bearer information) to the network entity 702.

Accordingly, for example, as shown in FIG. 9, operations 900 begin at 915 with the application layer 710 of the UE 704 receiving an indication of one or more PDU session IDs and one or more a QoS flow IDs. As shown, the indication of the one or more PDU session IDs and one or more QoS flow IDs may be received by the application layer 710 from the NAS layer 708, which may be aware of this information.

Thereafter, as illustrated at 920, the application layer 710 of the UE 704 may perform one or QoE measurements and generate a QoE report including the one or more QoE measurements. In some cases, the one or more QoE measurements may target one or more PDU sessions or one or more QoS flows identified by the one or more PDU session IDs and one or more QoS flow IDs received from the NAS layer 708. In some cases, the one or more QoE measurements may target a particular radio bearer associated with the UE 704. In some cases, the one or more QoE measurements may comprise “regular” (e.g., non-RAN visible) QoE measurements or RAN-visible QoE measurements.

In some cases, the UE 704 may receive, from the network entity 702, an indication of at least one a PDU session to perform the one or more QoE measurements for, a QoS flow to perform the one or more QoE measurements for, or a radio bearer to perform the one or more QoE measurements for. In such cases, performing the one or more QoE measurements in block 920 may comprise performing the one or more QoE measurements for the at least one of the indicated PDU session, the indicated QoS flow, or the indicated radio bearer.

Thereafter, as illustrated at 925 and 930, the application layer 710 sends the QoE report and the indication of the one or more PDU session IDs and the one or more QoS flow IDs to the AS layer 706 of the UE 704. Thereafter, as illustrated at 935, the AS layer 706 determines radio bearer information associated with the UE 704 based on at least one of the one or more PDU session IDs or the one or more QoS flow IDs received from the application layer at 930. In some cases, the radio bearer information comprises an indication of at least one of: a secondary cell group associated with the one or more QoE measurements, a master cell group associated with the one or more QoE measurements, a split bearer associated with the one or more QoE measurements, or a radio bearer ID associated with the one or more QoE measurements.

In some cases, the AS layer 706 may determine the radio bearer information based on a mapping between radio bearers associated with the UE 704 and at least one of the one or more PDU session IDs or the one or more QoS flow IDs. In some cases, as shown at 940, the network entity 702 transmits, to the UE 704 (e.g., to the AS layer 706), an indication of the mapping between the radio bearers associated with the UE 704 and at least one of the one or more PDU session IDs or the one or more QoS flow IDs. In some cases, the network entity 702 transmits the mapping to the UE 704 in RRC signaling. Accordingly, the AS layer 706 may use the received mapping and the indication of the one or more PDU session IDs and/or the one or more QoS flow IDs to determine the radio bearer information.

Thereafter, as illustrated at 945, the UE 704 transmits the QoE report, including the one or more QoE measurements, to the network entity 702. In some cases, as shown, transmitting the QoE report to the network entity 702 comprises transmitting the QoE report to the network entity 702 from the AS layer 706 of the UE 704. Further, as shown at 950, the UE 704 transmits connection identification information associated with the one or more QoE measurements to the network entity 702. In some cases, the connection identification information includes the bearer information determined at 935 by the AS layer 706. In some cases, transmitting the connection identification information to the network entity 702 comprises transmitting, from the AS layer 706 of the UE 704, the radio bearer information to the network entity 702 separately from the QoE report. In some cases, the connection identification information indicates that the one or more QoE measurements in the QoE report are associated with one or more radio bearers identified by the radio bearer information.

FIG. 10 illustrates techniques in which the AS layer 706 of the UE 704 provides radio bearer information to the application layer 710 of the UE 704. The application layer 710 may then include connection identification information (e.g., including the radio bearer information) within the QoE report, which may then be sent to the network entity 702.

For example, as shown, operations 1000 in FIG. 10 begin at 1015 with the application layer 710 of the UE 704 receiving an indication of one or more PDU session IDs and one or more a QoS flow IDs. Thereafter, as illustrated at 1020, the application layer 710 sends the indication of the one or more PDU session IDs and the one or more QoS flow IDs to the AS layer 706 of the UE 704. Thereafter, as illustrated at 1025, the AS layer 706 determines radio bearer information based on at least one of the one or more PDU session IDs or the one or more QoS flow IDs received from the application layer at 1020. In some cases, the AS layer 706 may determine the radio bearer information in a similar manner as block 935 in FIG. 9.

Thereafter, as illustrated at 1030, the AS layer 706 sends the radio bearer information to the application layer 710. The application layer 710 of the UE 704 may then perform one or QoE measurements and generate a QoE report including the one or more QoE measurements, as illustrated at 1035. In some cases, the one or more QoE measurements may target one or more PDU sessions or one or more QoS flows identified by the one or more PDU session IDs and one or more QoS flow IDs received from the NAS layer 708. In some cases, the one or more QoE measurements may target a particular radio bearer associated with the UE 704 identified by the radio bearer information received from the AS layer 706. In some cases, the one or more QoE measurements may comprise “regular” (e.g., non-RAN visible) QoE measurements or RAN-visible QoE measurements.

As shown at 1040, the application layer 710 may send the QoE report generated in block 1035 to the AS layer 706. In some cases, because the application layer 710 has received the radio bearer information from the AS layer 706, the application layer 710 may include connection identification information (e.g., including the radio bearer information) within the QoE report sent to the AS layer 706. Thereafter, as illustrated at 1045, the UE 704 transmits the QoE report, including one or more QoE measurements, and the connection identification information associated with the one or more QoE measurements to the network entity 702. In some cases, transmitting the connection identification information to the network entity 702 comprises transmitting the radio bearer information within the QoE report. In some cases, the connection identification information indicates that the one or more QoE measurements in the QoE report are associated with one or more radio bearers identified by the radio bearer information

### Example Call Flows Illustrating Operations for Identifying a Communication Interface Targeted by QoE Measurements

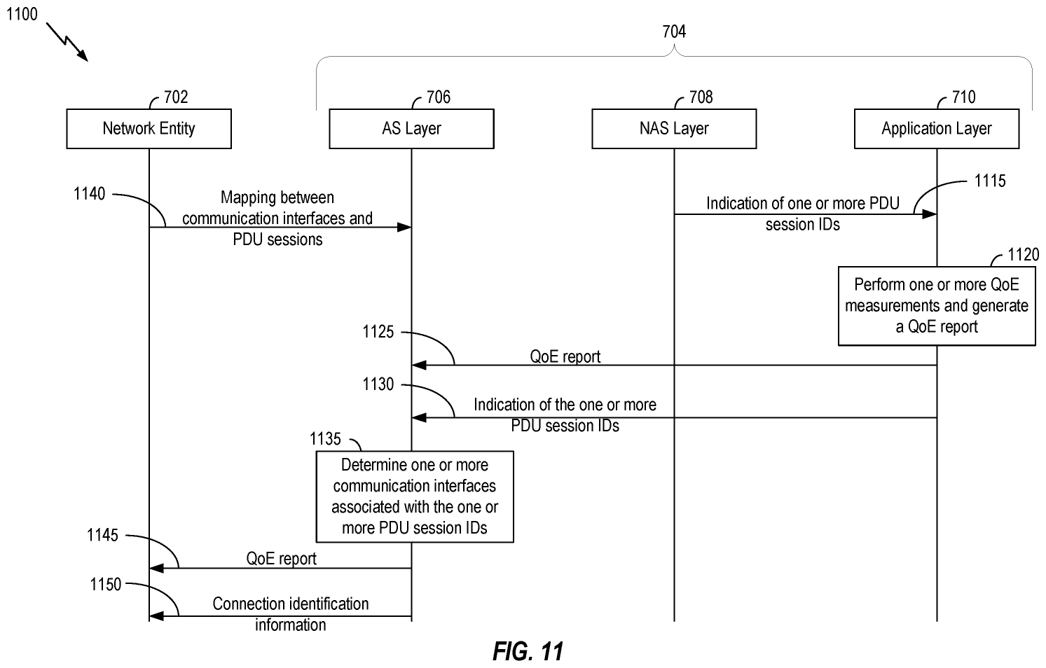

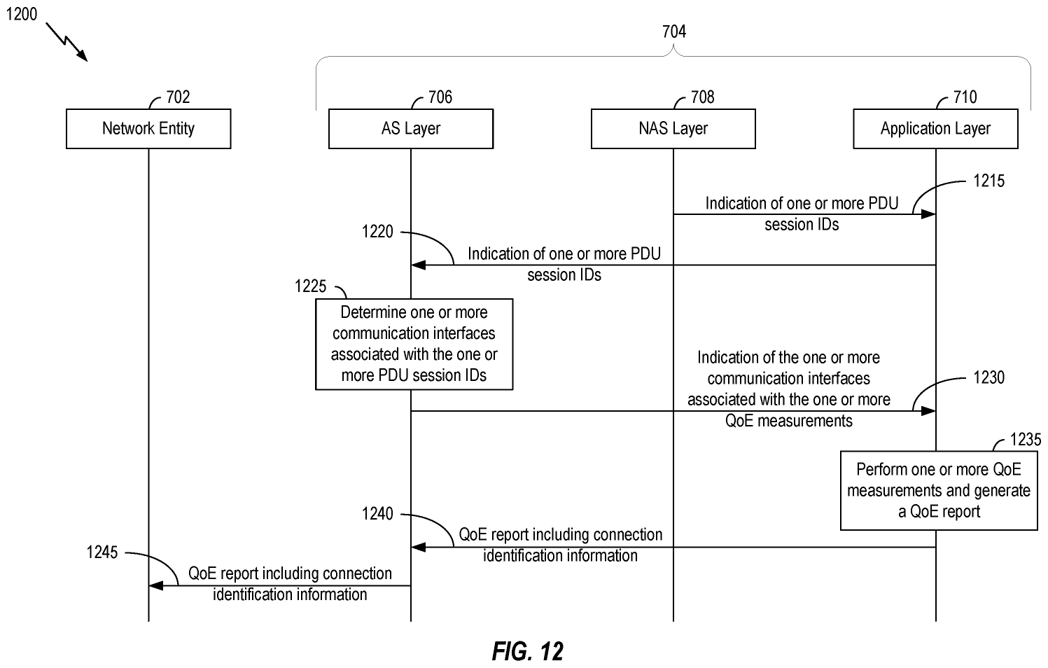

FIGS. 11 and 12 are call flow diagrams illustrating example operations 1100 and 1200, respectively, for identifying a communication interface (e.g., an MN interface and/or an SN interface) targeted by one or more QoE measurements in a QoE report. As shown, the operations 1100 and 1200 may be performed by the network entity 702 and one or more protocol stack layers of the UE 704, such as the AS layer 706, the NAS layer 708, and/or the application layer 710.

FIG. 11 illustrates techniques in which the application layer 710 of the UE 704 provides the QoE report to the AS layer 706 of the UE 704 and the AS layer 706 separately sends the QoE report and connection identification information (e.g., communication interface information) to the network entity 702.

Accordingly, for example, as shown in FIG. 11, operations 1100 begin at 1115 with the application layer 710 of the UE 704 receiving an indication of one or more PDU session IDs. As shown, the indication of the one or more PDU session IDs may be received by the application layer 710 from the NAS layer 708, which may be aware of this information.

Thereafter, as illustrated at 1120, the application layer 710 of the UE 704 may perform one or QoE measurements and generate a QoE report including the one or more QoE measurements. In some cases, the one or more QoE measurements may target one or more PDU sessions identified by the one or more PDU session IDs received from the NAS layer 708. In some cases, the one or more QoE measurements may target a particular communication interface (e.g., MN interface and/or SN interface) associated with the UE 704. In some cases, the UE 704 may receive, from the network entity 702, an indication of one or more communication interfaces to perform the one or more QoE measurements for. In such cases, performing the one or more QoE measurements in block 920 may performing the one or more QoE measurements for the indicated one or more communication interfaces. In some cases, the one or more QoE measurements may comprise “regular” (e.g., non-RAN visible) QoE measurements or RAN-visible QoE measurements.

Thereafter, as illustrated at 1125 and 1130, the application layer 710 sends the QoE report and the indication of the one or more PDU session IDs to the AS layer 706 of the UE 704. Thereafter, as illustrated at 1135, the AS layer 706 determines one or more communication interfaces associated with the UE 704 based on the one or more PDU session IDs received from the application layer at 1130. In some cases, the one or more communication interfaces comprise at least one of an MN interface of a dual connectivity configuration or an SN interface of the dual connectivity configuration.

In some cases, the AS layer 706 may determine the one or more communication interfaces based on a mapping between communication interfaces associated with the UE 704 and the one or more PDU session IDs. In some cases, as shown at 1140, the network entity 702 transmits, to the UE 704 (e.g., to the AS layer 706), an indication of the mapping between the communication interfaces associated with the UE 704 and the one or more PDU session IDs. In some cases, when the network entity 702 comprises a base station (e.g., BS 102), the network entity 702 transmits the mapping to the UE 704 in RRC signaling. In other cases, when the network entity 702 comprises a core network entity, the network entity 702 transmits the mapping to the UE 704 in NAS signaling. In either case, the AS layer 706 may use the received mapping and the indication of the one or more PDU session IDs to determine the one or more communication interfaces associated with the one or more QoE measurements that are mapped to the one or more PDU session IDs.

Further, in some cases, the AS layer 706 may determine the one or more communication interfaces based on a mapping between communication interfaces associated with the UE 704 and one or more radio bearer IDs associated with the UE 704. In some cases, the network entity 702 transmits, to the UE 704 (e.g., to the AS layer 706), an indication of the mapping between the communication interfaces associated with the UE 704 and the one or more radio bearer IDs. In some cases, when the network entity 702 comprises a base station (e.g., BS 102), the network entity 702 transmits the mapping to the UE 704 in RRC signaling. In other cases, when the network entity 702 comprises a core network entity, the network entity 702 transmits the mapping to the UE 704 in NAS signaling. In some cases, the AS layer 706 may determine radio bearer information (e.g., the one or more radio bearer IDs) using techniques described above with respect to FIGS. 9 and 10. The AS layer 706 may then use the radio bearer information and the mapping to determine the one or more communication interfaces.

Thereafter, as illustrated at 1145, the UE 704 transmits the QoE report, including the one or more QoE measurements, to the network entity 702. In some cases, as shown, transmitting the QoE report to the network entity 702 comprises transmitting the QoE report to the network entity 702 from the AS layer 706 of the UE 704. Further, as shown at 1150, the UE 704 transmits connection identification information associated with the one or more QoE measurements to the network entity 702. In some cases, the connection identification information includes indication of the one or more communication interfaces determined at 1135 by the AS layer 706. In some cases, transmitting the connection identification information to the network entity 702 comprises transmitting, from the AS layer 706 of the UE 704, the indication of the one or more communication interfaces to the network entity 702 separately from the QoE report. In some cases, the connection identification information indicates that the one or more QoE measurements in the QoE report are associated with one or more communication interfaces identified by the indication of the one or more communication interfaces.

FIG. 12 illustrates techniques in which the AS layer 706 of the UE 704 provides an indication of one or more communication interfaces to the application layer 710 of the UE 704. The application layer 710 may then include connection identification information, including the indication of one or more communication interfaces, within the QoE report, which may then be sent to the network entity 702.

For example, as shown, operations 1200 in FIG. 12 begin at 1215 with the application layer 710 of the UE 704 receiving an indication of one or more PDU session IDs. Thereafter, as illustrated at 1220, the application layer 710 sends the indication of the one or more PDU session IDs to the AS layer 706 of the UE 704. Thereafter, as illustrated at 1225, the AS layer 706 determines one or more communication interfaces associated with the UE 704 based on the one or more PDU session IDs received from the application layer at 1220. In some cases, the AS layer 706 may determine the one or more communication interfaces in a similar manner as block 1135 in FIG. 11.

Thereafter, as illustrated at 1230, the AS layer 706 sends an indication of the one or more communication interfaces to the application layer 710. The application layer 710 of the UE 704 may then perform one or QoE measurements and generate a QoE report including the one or more QoE measurements, as illustrated at 1235. In some cases, the one or more QoE measurements may target one or more PDU sessions identified by the one or more PDU session IDs received from the NAS layer 708. In some cases, the one or more QoE measurements may target a particular communication interface associated with the UE 704 identified by the indication of the one or more communication interfaces received from the AS layer 706. In some cases, the one or more QoE measurements may comprise “regular” (e.g., non-RAN visible) QoE measurements or RAN-visible QoE measurements.

As shown at 1240, the application layer 710 may send the QoE report generated in block 1235 to the AS layer 706. In some cases, because the application layer 710 has received the indication of the one or more communication interfaces from the AS layer 706, the application layer 710 may include connection identification information (e.g., including the indication of the one or more communication interfaces) within the QoE report sent to the AS layer 706. Thereafter, as illustrated at 1245, the UE 704 transmits the QoE report, including one or more QoE measurements, and the connection identification information associated with the one or more QoE measurements to the network entity 702. In some cases, transmitting the connection identification information to the network entity 702 comprises transmitting the indication of the one or more communication interfaces within the QoE report. In some cases, the connection identification information indicates that the one or more QoE measurements in the QoE report are associated with one or more communication interfaces identified by the indication of the one or more communication interfaces.

### Example Call Flows Illustrating Operations for Identifying a Sidelink Interface or Access Type Targeted by QoE Measurements

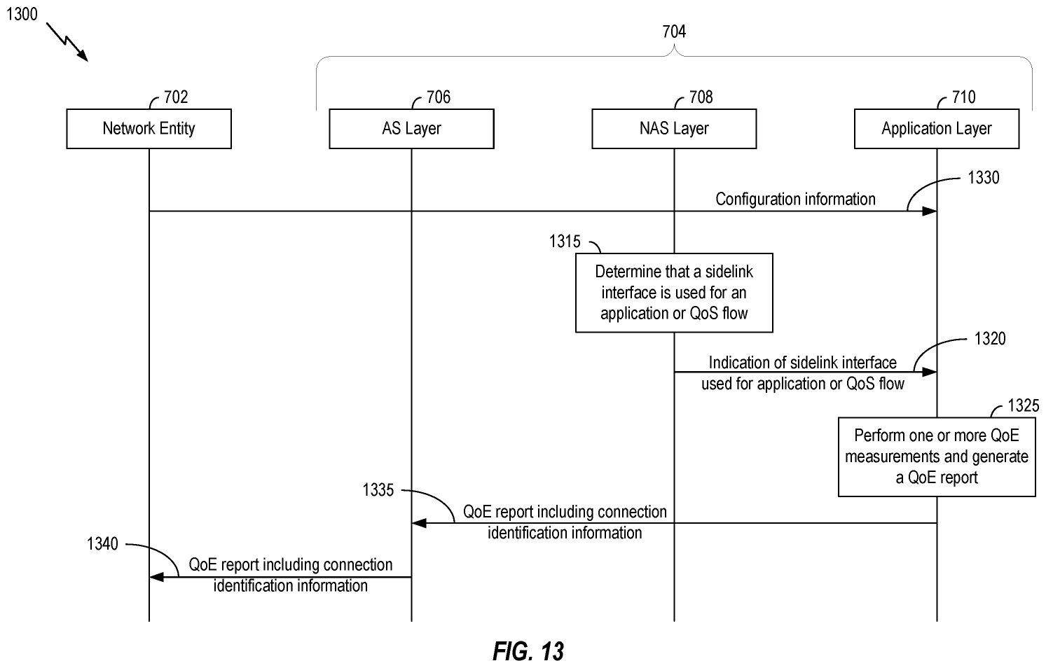

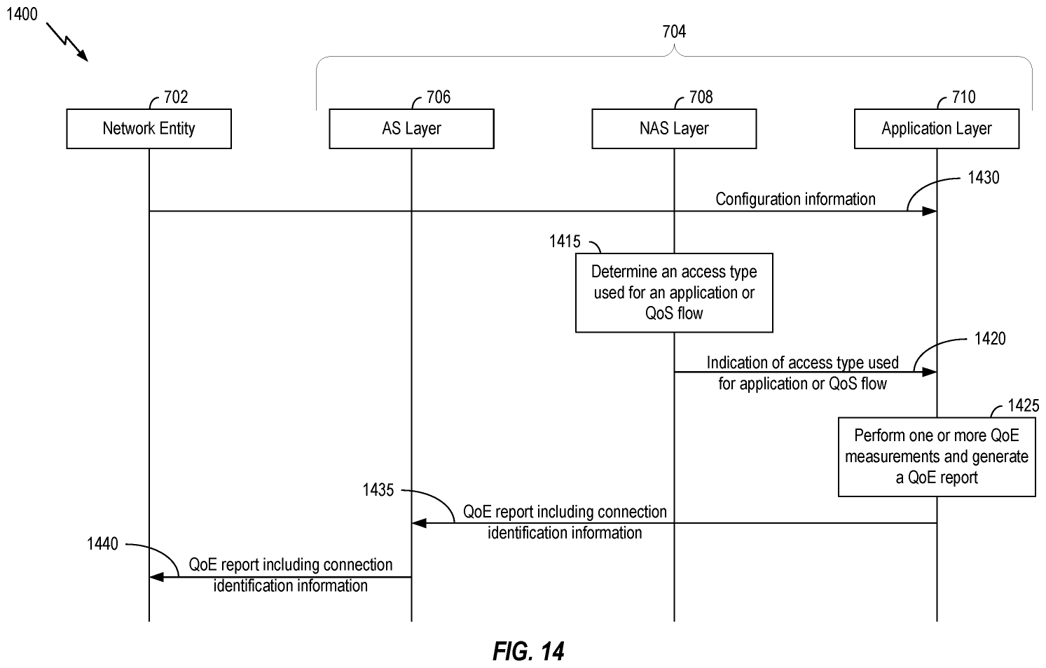

FIGS. 13 and 14 are call flow diagrams illustrating example operations 1300 and 1400, respectively, for identifying a sidelink interface (e.g., PC5 interface) and/or access type targeted by one or more QoE measurements in a QoE report. As shown, the operations 1300 and 1400 may be performed by the network entity 702 and one or more protocol stack layers of the UE 704, such as the AS layer 706, the NAS layer 708, and/or the application layer 710.

FIG. 13 illustrates techniques in which the NAS layer 708 of the UE 704 provides an indication to the application layer 710 that a sidelink interface is used for one or more applications associated with the UE 704 and/or one or more service flows (e.g., internet protocol (IP) flows) associated with the UE 704. The application layer 710 may then include connection identification information (e.g., including the indication that the sidelink interface is used for the one or more applications and/or one or more service flows) within the QoE report, which may then be sent to the network entity 702.

For example, operations 1300 illustrated in FIG. 13 begin at 1315 with the NAS layer 708 of the UE 704 determining that a sidelink interface, such as a PC5 interface, is used for at least one of one or more applications associated with the UE 704 or one or more service flows associated with the UE 704. In some cases, the NAS layer 708 may determine that the sidelink interface is used for the application or the service flow based on one or more rules. The one or more rules may include a vehicle-to-everything (V2X) rule or a ProSe rule. In some cases, the V2X rule and/or the ProSe rule may be received from the network entity 702.

Thereafter, as illustrated at 1320, based on the determination that the sidelink interface is used for at least one of the one or more applications associated with the UE or the one or more service flows associated with the UE 707, the NAS layer 708 sends an indication of the sidelink interface to the application layer 710 of the UE. In some cases, the NAS layer 708 may send the indication of the sidelink interface to the application layer 710 in an attention (AT) command.

The application layer 710 of the UE 704 may then perform one or QoE measurements and generate a QoE report including the one or more QoE measurements, as illustrated at 1325. In some cases, the one or more QoE measurements may target the sidelink interface indicated by the NAS layer 708. In some cases, the one or more QoE measurements may target the one or more applications or one or more service flows associated with the sidelink interface indicated by the NAS layer 708. In some cases, the one or more QoE measurements may comprise “regular” (e.g., non-RAN visible) QoE measurements or RAN-visible QoE measurements.

In some cases, the network entity 702 may configure the UE 704 to perform QoE measurements for the one or more applications or one or more service flows running on sidelink interface. For example, in some cases, the network entity 702 may send configuration information to the UE 704 (e.g., via the AS layer 706 and application layer 710) at 1330 instructing the UE 704 to perform the one or more QoE measurements for one or more applications or the one or more service flows associated with the sidelink interface. The application layer 710 may then perform the one or more QoE measurements targeting the one or more applications or one or more service flows associated with the sidelink interface based on the configuration information received from the network entity 702.

As shown at 1335, the application layer 710 sends the QoE report generated in block 1325 to the AS layer 706. In some cases, because the application layer 710 has received the indication of the sidelink interface from the NAS layer 708, the application layer 710 may include connection identification information associated with the one or more QoE measurements (e.g., including the indication of the sidelink interface) within the QoE report sent to the AS layer 706. Thereafter, as illustrated at 1340, the UE 704 transmits the QoE report, including one or more QoE measurements, and the connection identification information associated with the one or more QoE measurements to the network entity 702. In some cases, transmitting the connection identification information to the network entity 702 comprises transmitting the indication of the sidelink interface within the QoE report. In some cases, the connection identification information indicates that the one or more QoE measurements in the QoE report are associated with a sidelink interface identified by the indication of the sidelink interface.

In some cases, for RAN-visible QoE, the application layer 710 may transmit the indication of the sidelink interface to the AS layer 706 along with the QoE report within a RAN-visible container.

FIG. 14 illustrates techniques in which the NAS layer 708 of the UE 704 provides an indication to the application layer 710 that a particular access type is used for one or more applications associated with the UE 704 and/or one or more service flows associated with the UE 704. The application layer 710 may then include connection identification information (e.g., including the indication of the access type used for the one or more applications and/or one or more service flows) within the QoE report, which may then be sent to the network entity 702.

For example, operations 1400 illustrated in FIG. 13 begin at 1415 with the NAS layer 708 of the UE 704 determining that an access type, such as a non-third generation partnership project (3GPP) access type like Wi-Fi, is used for at least one of one or more applications associated with the UE 704 or one or more service flows associated with the UE 704. In some cases, the NAS layer 708 may determine that the access type is used for the application or the service flow based on one or more rules. The one or more rules may include an access traffic steering, switching and splitting (ATSSS) rule. In some cases, the ATSSS rule may be received from the network entity 702.

Thereafter, as illustrated at 1420, based on the determination that the access type is used for at least one of the one or more applications associated with the UE or the one or more service flows associated with the UE 707, the NAS layer 708 sends an indication of the access type to the application layer 710 of the UE. In some cases, the NAS layer 708 may send the indication of the sidelink interface to the application layer 710 in an attention (AT) command.

The application layer 710 of the UE 704 may then perform one or QoE measurements and generate a QoE report including the one or more QoE measurements, as illustrated at 1425. In some cases, the one or more QoE measurements may target the access type indicated by the NAS layer 708. In some cases, the one or more QoE measurements may target the one or more applications or one or more service flows associated with the access type indicated by the NAS layer 708. In some cases, the one or more QoE measurements may comprise “regular” (e.g., non-RAN visible) QoE measurements or RAN-visible QoE measurements.

In some cases, the network entity 702 may configure the UE 704 to perform QoE measurements for the one or more applications or one or more service flows running on access type. For example, in some cases, the network entity 702 may send configuration information to the UE 704 (e.g., via the AS layer 706 and application layer 710) at 1430 instructing the UE 704 to perform the one or more QoE measurements for one or more applications or the one or more service flows associated with the access type. The application layer 710 may then perform the one or more QoE measurements targeting the one or more applications or one or more service flows associated with the access type based on the configuration information received from the network entity 702.

As shown at 1435, the application layer 710 sends the QoE report generated in block 1425 to the AS layer 706. In some cases, because the application layer 710 has received the indication of the access type from the NAS layer 708, the application layer 710 may include connection identification information associated with the one or more QoE measurements (e.g., including the indication of the access type) within the QoE report sent to the AS layer 706. Thereafter, as illustrated at 1440, the UE 704 transmits the QoE report, including one or more QoE measurements, and the connection identification information associated with the one or more QoE measurements to the network entity 702. In some cases, transmitting the connection identification information to the network entity 702 comprises transmitting the indication of the access type within the QoE report. In some cases, the connection identification information indicates that the one or more QoE measurements in the QoE report are associated with an access type identified by the indication of the access type.

In some cases, for RAN-visible QoE, the application layer 710 may transmit the indication of the access type to the AS layer 706 along with the QoE report within a RAN-visible container.

### Example Call Flows Illustrating Operations for Identifying a Cell Targeted by QoE Measurements

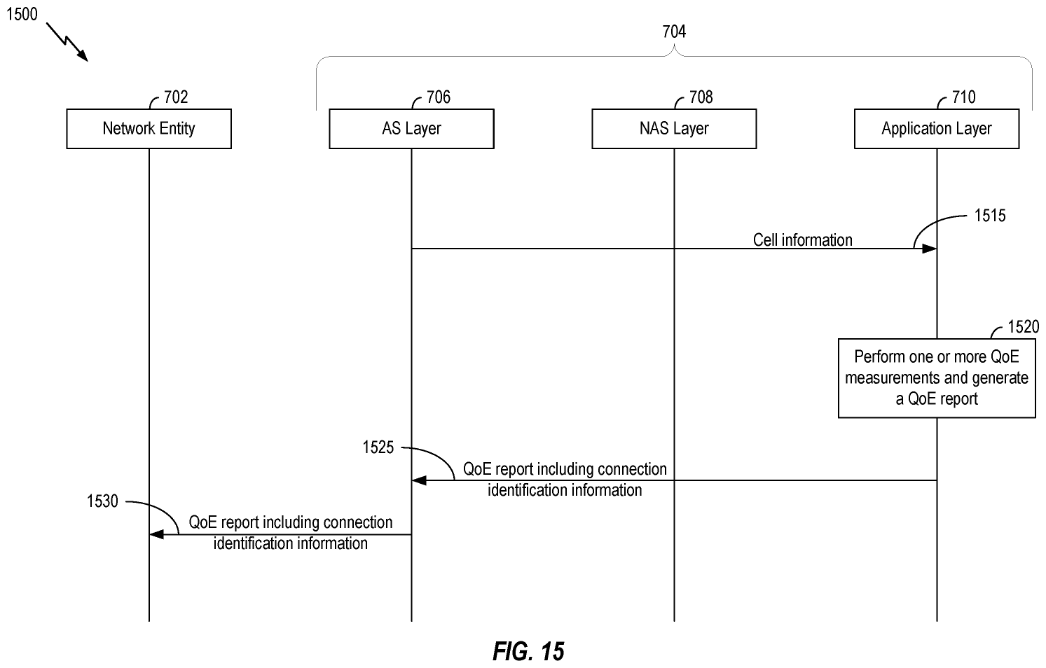

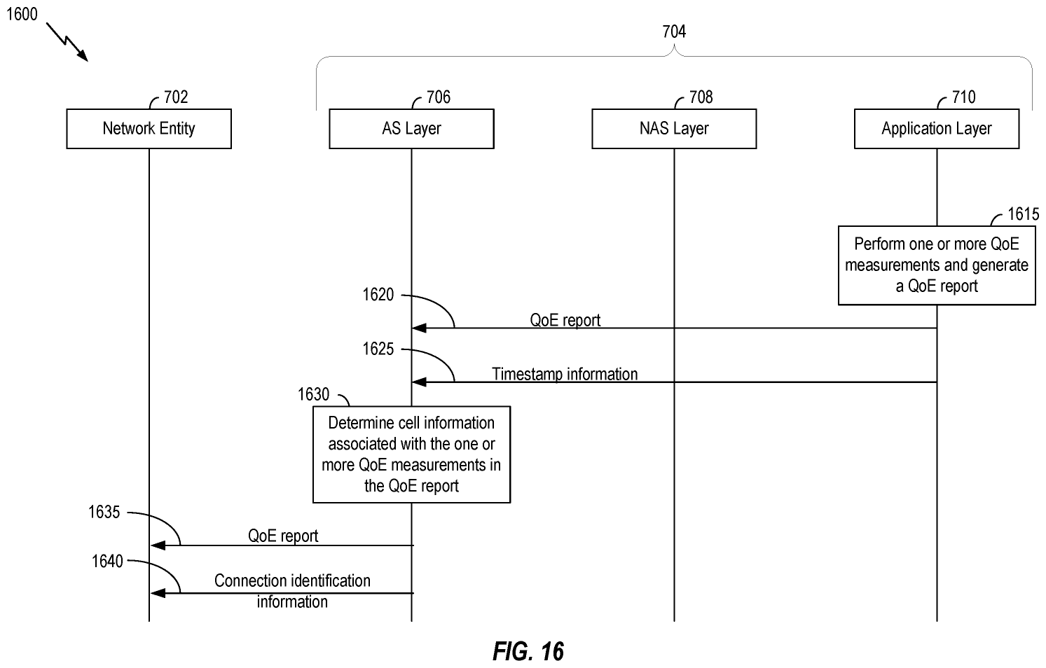

FIGS. 15 and 16 are call flow diagrams illustrating example operations 1500 and 1600, respectively, for identifying a cell information associated with one or more QoE measurements in a QoE report. As shown, the operations 1500 and 1600 may be performed by the network entity 702 and one or more protocol stack layers of the UE 704, such as the AS layer 706, the NAS layer 708, and/or the application layer 710.

FIG. 15 illustrates techniques in which the AS layer 706 of the UE 704 provides cell information (e.g., a cell ID) associated with the UE 704 to the application layer 710. The application layer 710 may then include connection identification information (e.g., including the cell information) within the QoE report, which may then be sent to the network entity 702.

For example, as shown, operations 1500 in FIG. 15 begin at 1515 with the application layer 710 of the UE 704 receiving cell information (e.g., a cell ID) associated with the UE 704 from the AS layer 706. In some cases, the AS layer 706 may be configured to send the cell information to the application layer when QoE measurements are configure. In some cases, the AS layer 706 may be configured to send the cell information to the application layer when the UE 704 enters and idle or inactive state. In some cases, the AS layer 706 may be configured to send the cell information to the application layer when the cell information changes (e.g., the UE 704 enters a new cell).

Thereafter, as illustrated at 1520, the application layer 710 performs one or QoE measurements and generates a QoE report including the one or more QoE measurements. In some cases, the one or more QoE measurements may target a cell identified by the cell information received from the AS layer 706. In some cases, the one or more QoE measurements may comprise “regular” (e.g., non-RAN visible) QoE measurements or RAN-visible QoE measurements.

In some cases, when generating the QoE report, the application layer 710 may include connection identification information, including the cell information for, each QoE measurement of the one or more QoE measurements within the QoE report. In other words, the application layer 710 may include connection identification information within the QoE report that indicates a cell, identified by the cell information, to which the QoE measurements of the one or more QoE measurements correspond. In some cases, rather than include the cell information within the QoE report, the application layer 710 may provide an indication of whether the cell information is the same as or different from the cell information for previous QoE measurements.

Thereafter, as illustrated at 1525, the application layer 710 sends the QoE report generated in block 1520 to the AS layer 706, including the connection identification information (e.g., cell information) associated with the one or more QoE measurements. Thereafter, as illustrated at 1530, the UE 704 transmits the QoE report, including one or more QoE measurements, and the connection identification information associated with the one or more QoE measurements to the network entity 702. In some cases, transmitting the connection identification information to the network entity 702 comprises transmitting the cell information within the QoE report, indicating the one or more QoE measurements in the QoE report are associated with the cell information (e.g., associated with a cell identified by the cell information).

In some cases, for RAN-visible QoE, the application layer 710 may transmit the cell information (or indication of whether the cell information is the same or different from previous QoE measurements) to the AS layer 706 along with the QoE report within a RAN-visible container. Thereafter, the AS layer 706 may transmit the RAN-visible container including the QoE report to the network entity 702 and indicate, for each QoE measurement in the QoE report, the cell information for that QoE measurement or whether the cell information is the same or different as a previous QoE measurement.

FIG. 16 illustrates techniques in which application layer 710 sends a QoE report to the AS layer 706 along with timestamp information associated with one or more QoE measurements in the QoE report. The AS layer 706 may then determine cell information based on the timestamp information and sends the cell information along with the QoE report to the network entity 702.

For example, as shown, operations 1600 in FIG. 15 begin at 1615 with the application layer 710 of the UE 704 performs one or QoE measurements and generates a QoE report including the one or more QoE measurements. In some cases, the one or more QoE measurements may comprise “regular” (e.g., non-RAN visible) QoE measurements or RAN-visible QoE measurements. In some cases, the application layer 710 may also determine timestamp information for each QoE measurement of the one or more QoE measurements. The timestamp information may be indicative of a particular cell in which the UE 704 is operating when the one or more QoE measurements are performed.

Thereafter, as illustrated at 1620, the application layer 710 sends the QoE report, including the one or more QoE measurements, to the AS layer 706. Further, as illustrated at 1625, the application layer 710 sends the timestamp information to the AS layer 706 for each QoE measurement of the one or more QoE measurements in the QoE report.

In some cases, the AS layer 706 of the UE 704 may maintain a cell history list including a plurality of cells and corresponding timestamps. In other words, the cell history list may indicate which cell the UE 704 is operating in at any given timestamp. Thereafter, as shown in block 1630, the AS layer 706 determines cell information associated with the one or more QoE measurements in the QoE report based on the cell history list and the timestamp information received at 1625 for each QoE measurement of the one or more QoE measurements.

Thereafter, as illustrated at 1635, the UE 704 transmits the QoE report, including the one or more QoE measurements, to the network entity 702. In some cases, as shown, transmitting the QoE report to the network entity 702 comprises transmitting the QoE report to the network entity 702 from the AS layer 706 of the UE 704. Further, as shown at 1640, the UE 704 transmits connection identification information associated with the one or more QoE measurements to the network entity 702. In some cases, transmitting the connection identification information to the network entity comprises transmitting, from the AS layer 706 of the UE 704, the cell information (e.g., determined at 1630) separately from the QoE report. In some cases, the connection identification information indicates the one or more QoE measurements in the QoE report are associated with the cell information. In some cases, transmitting the connection identification information to the network entity 702 comprises transmitting, from the AS layer 706 of the UE 704, an indication of whether the cell information associated with a QoE measurement in the one or more QoE measurements is the same as a previous QoE measurement transmitted to the network entity 702.

### Example Methods for Communicating Uplink and Downlink Transmissions When a Semi-Statically Configured Scheduling Occasion Is Overwritten by an SFI

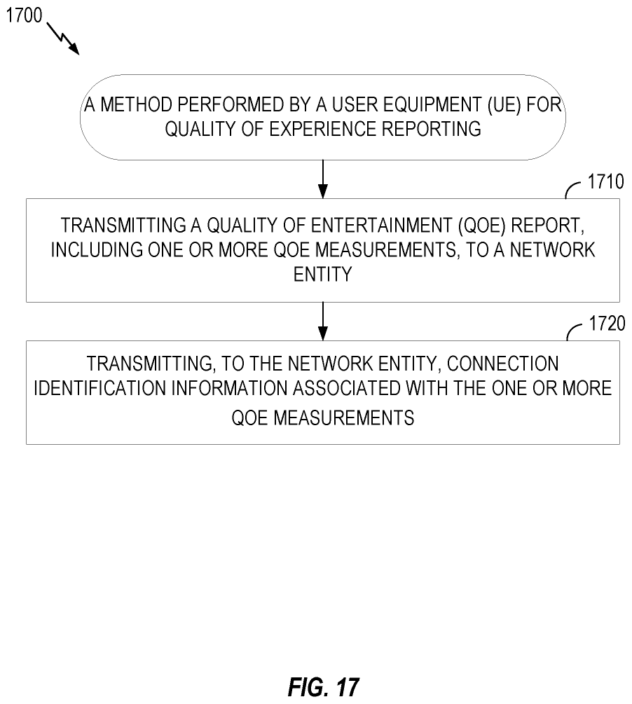

FIG. 17 is a flow diagram illustrating example operations 1700 for wireless communication, in accordance with certain aspects of the present disclosure. The operations 700 may be performed, for example, by a UE (e.g., such as the UE 104 in the wireless communication network 100 of FIG. 1 and/or UE 704 illustrated in FIGS. 7-16) for reporting QoE. The operations 1700 may be implemented as software components that are executed and run on one or more processors (e.g., controller/processor 280 of FIG. 2). Further, the transmission and reception of signals by the UE in operations 1700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1700 begin, at 1710, transmitting a quality of entertainment (QoE) report, including one or more QoE measurements, to a network entity.

In block 1720, the UE transmits, to the network entity, connection identification information associated with the one or more QoE measurements.

In some cases, the connection identification information comprises at least one of: quality of service (QOS) flow identifier associated with the one or more QoE measurements, protocol data unit (PDU) session identifier associated with the one or more QoE measurements, a radio bearer information associated with the one or more QoE measurements, a communication interface associated with the one or more QoE measurements, an access type associated with the one or more QoE measurements, or a cell identifier associated with the one or more QoE measurements.

In some cases, operations 1700 further include performing the one or more QoE measurements and generating the QoE report in an application layer of the UE.

In some cases, operations 1700 further include receiving, at the application layer of the UE from a non access stratum (NAS) layer of the UE, an indication of one or more protocol data unit (PDU) session IDs, wherein the connection identification information comprises the one or more PDU session IDs.

In some cases, transmitting the connection identification information to the network entity in block 1720 comprises transmitting the one or more PDU session IDs within the QoE report, indicating the one or more QoE measurements in the QoE report are associated with one or more PDU sessions identified by the one or more PDU session IDs.

In some cases, the application layer of the UE includes a plurality of PDU sessions. Further, in some cases, the one or more QoE measurements are associated with a subset of PDU sessions of the plurality of PDU session. Further, in some cases, the one or more PDU session IDs include a set of PDU session IDs. Further, in some cases, each different PDU session ID within the set of PDU session IDs corresponds to a different PDU session in the subset of PDU sessions.

In some cases, operations 1700 further include receiving, at the application layer of the UE from the NAS layer of the UE, an indication of one or more a quality of service (QOS) flow identifiers (IDs), wherein the connection identification information further comprises the one or more QoS flow IDs.

In some cases, transmitting the connection identification information to the network entity in block 1720 comprises transmitting the one or more QoS flow IDs within the QoE report, indicating the one or more QoE measurements in the QoE report are associated with one or more QoS flows identified by the one or more QoS flow IDs.

In some cases, the application layer of the UE includes at least a first PDU session. Further, in some cases, the first PDU session includes a plurality of QoS flows. Further in some cases, the one or more QoE measurements are associated with a subset of QoS flows of the plurality of QoS flows. Further, in some cases, the one or more QoS flow IDs include a set of QoS flow IDs. Further, in some cases, each different QoS flow ID within the set of QoS flow IDs corresponds a different QoS flow in the subset of QoS flows.

In some cases, operations 1700 further include sending the QoE report and the one or more PDU session IDs from the application layer to an access stratum (AS) layer of the UE. In such cases, transmitting the QoE report to the network entity in block 1710 comprises transmitting the QoE report to the network entity from the AS layer of the UE. Additionally, in some cases, transmitting the connection identification information to the network entity in block 1720 comprises transmitting, from the AS layer of the UE, the one or more PDU session IDs to the network entity separately from the QoE report, the connection identification information indicating the one or more QoE measurements in the QoE report are associated with one or more PDU sessions identified by the one or more PDU session IDs.

In some cases, operations 1700 further include receiving, at the application layer of the UE from the NAS layer of the UE, an indication of one or more a quality of service (QOS) flow identifiers (IDs). Additionally, in some cases, operations 1700 further include sending the one or more QoS flow IDs from the application layer to the AS layer of the UE, wherein transmitting the connection identification information to the network entity further comprises transmitting, from the AS layer of the UE, the one or more Qos flow IDs to the network entity separately from the QoE report, the connection identification information indicating the one or more QoE measurements in the QoE report are associated with one or more QoS flows identified by the one or more QoS flow IDs.

In some cases, operations 1700 further include receiving, at the application layer of the UE from a non access stratum (NAS) layer of the UE, an indication of one or more protocol data unit (PDU) session IDs and one or more a quality of service (QOS) flow identifiers (IDs).

In some cases, operations 1700 further include sending the one or more PDU session IDs and the one or more QoS flow IDs from the application layer of the UE to an access stratum (AS) layer of the UE. Additionally, in some cases, operations 1700 further include determining, by the AS layer of the UE, radio bearer information associated with the one or more QoE measurements based on at least one of the one or more PDU session IDs or the one or more QoS flow IDs. In some cases, determining the radio bearer information is based on a mapping between radio bearers associated with the UE and at least one of the one or more PDU session IDs or the one or more QoS flow IDs. In some cases, the radio bearer information comprises an indication of at least one of: a secondary cell group, a master cell group, a split bearer, or a radio bearer ID.

In some cases, operations 1700 further include sending the QoE report from the application layer of the UE to the AS layer of the UE. In some cases, the connection identification information comprises the radio bearer information. Further, in some cases, transmitting the QoE report to the network entity in block 1710 comprises transmitting the QoE report to the network entity from the AS layer of the UE. Additionally, in some cases, transmitting the connection identification information to the network entity in block 1720 comprises transmitting, from the AS layer of the UE, the radio bearer information to the network entity separately from the QoE report, the connection identification information indicating, the one or more QoE measurements in the QoE report are associated with one or more radio bearers identified by the radio bearer information.

In some cases, operations 1700 further include sending the radio bearer information from the AS layer of the UE to the application layer of the UE. In some cases, transmitting the connection identification information to the network entity in block 1720 comprises transmitting the radio bearer information within the QoE report, the connection identification information indicating the one or more QoE measurements in the QoE report are associated with one or more radio bearers identified by the radio bearer information.

In some cases, operations 1700 further include receiving, from the network entity, an indication of at least one a PDU session to perform the one or more QoE measurements for, a QoS flow to perform the one or more QoE measurements for, or a radio bearer to perform the one or more QoE measurements for. In some cases, performing the one or more QoE measurements comprises performing the one or more QoE measurements for the at least one of the indicated PDU session, the indicated QoS flow, or the indicated radio bearer.

In some cases, operations 1700 further include receiving, at the application layer of the UE from a non access stratum (NAS) layer of the UE, an indication of one or more protocol data unit (PDU) session IDs.

In some cases, operations 1700 further include sending the one or more PDU session IDs from the application layer of the UE to an access stratum (AS) layer of the UE. Additionally, in some cases, operations 1700 further include determining, by the AS layer of the UE, one or more communication interfaces associated with the one or more QoE measurements based on the one or more PDU session IDs. In some cases, the one or more communication interfaces comprise at least one of a master node (MN) interface of a dual connectivity configuration or a secondary node (SN) interface of the dual connectivity configuration.

In some cases, determining the one or more communication interfaces associated with the one or more QoE measurements is based on a mapping between communication interfaces and the one or more PDU session IDs. In some cases, the mapping is received in at least one of: radio resource control (RRC) signaling from the network entity, or NAS signaling from a core network associated with the network entity.

In some cases, determining the one or more communication interfaces associated with the one or more QoE measurements is based on a mapping between communication interfaces and one or more radio bearer IDs associated with the UE.

In some cases, operations 1700 further include sending the QoE report from the application layer of the UE to the AS layer of the UE. In some cases, the connection identification information comprises an indication of the one or more communication interfaces. In some cases, transmitting the QoE report to the network entity in block 1710 comprises transmitting the QoE report to the network entity from the AS layer of the UE. In some cases, transmitting the connection identification information to the network entity in block 1720 comprises transmitting, from the AS layer of the UE, the indication of the one or more communication interfaces to the network entity separately from the QoE report, the connection identification information indicating the one or more QoE measurements in the QoE report are associated with one or more communication interfaces identified by indication of the one or more communication interfaces.

In some cases, operations 1700 further include sending an indication of the one or more communication interfaces associated with the one or more QoE measurements from the AS layer of the UE to the application layer of the UE. In some cases, transmitting the connection identification information to the network entity in block 1720 comprises transmitting, from the application layer of the UE, the indication of the one or more communication interfaces associated with the one or more QoE measurements within the QoE report, the connection identification information indicating the one or more QoE measurements in the QoE report are associated with one or more communication interfaces identified by indication of the one or more communication interfaces.

In some cases, operations 1700 further include receiving, from the network entity, an indication of one or more communication interfaces to perform the one or more QoE measurements for. In some cases, performing the one or more QoE measurements comprises performing the one or more QoE measurements for the indicated one or more communication interfaces.

In some cases, operations 1700 further include determining, by a non-access stratum (NAS) layer of the UE, a sidelink interface is used for at least one of an application associated with the UE or a service flow associated with the UE based on one or more rules. In some cases, the one or more rules comprise a vehicle-to-everything (V2X) rule or a ProSe rule.

In some cases, operations 1700 further include sending an indication of the sidelink interface from the NAS layer of the UE to the application layer of the UE. In some cases, transmitting the connection identification information to the network entity in block 1720 comprises transmitting, from the application layer of the UE, the indication of the sidelink interface within the QoE report, indicating the one or more QoE measurements in the QoE report are associated with the sidelink interface.

In some cases, operations 1700 further include determining, by a non-access stratum (NAS) layer of the UE, an access type used for at least one of an application associated with the one or more QoE measurements or a service flow associated with the one or more QoE measurements based on one or more rules. In some cases, the one or more rules comprise an access traffic steering, switching and splitting (ATSSS) rule.

In some cases, operations 1700 further include sending an indication of the access type from the NAS layer of the UE to the application layer of the UE. In some cases, transmitting the connection identification information to the network entity in block 1720 comprises transmitting, from the application layer of the UE, the indication of the access type within the QoE report, indicating the one or more QoE measurements in the QoE report are associated with the access type.

In some cases, operations 1700 further include sending, from an access stratum (AS) layer of the UE to the application layer of the UE, cell information associated with the UE. In some cases, sending the cell information to the application layer comprises sending the cell information to the application layer when at least one of: the UE enters an idle state or an inactive state, or the cell information associated with the UE changes. In some cases, transmitting the connection identification information to the network entity in block 1720 comprises transmitting the cell information within the QoE report, indicating the one or more QoE measurements in the QoE report are associated with the cell information.

In some cases, operations 1700 further include sending, from the application layer of the UE to an access stratum (AS) layer of the UE, the QoE report including the one or more QoE measurements. Additionally, in some cases, operations 1700 further include sending, from the application layer of the UE to the AS layer of the UE, timestamp information for each QoE measurement of the one or more QoE measurements in the QoE report.

In some cases, operations 1700 further include maintaining, by the AS layer of the UE, a cell history list including a plurality of cells and corresponding timestamps. Additionally, in some cases, operations 1700 further include determining cell information associated with the one or more QoE measurements in the QoE report based on the cell history list and the timestamp information for each QoE measurement of the one or more QoE measurements.

In some cases, transmitting the QoE report to the network entity in block 1710 comprises transmitting the QoE report to the network entity from the AS layer of the UE. Additionally, in some cases, transmitting the connection identification information to the network entity in block 1720 comprises transmitting, from the AS layer of the UE, the cell information separately from the QoE report, the connection identification information indicating the one or more QoE measurements in the QoE report are associated with the cell information.

In some cases, transmitting the connection identification information to the network entity in block 1720 comprises transmitting, from the AS layer of the UE, an indication of whether the cell information associated with a QoE measurement in the one or more QoE measurements is the same as a previous QoE measurement transmitted to the network entity.

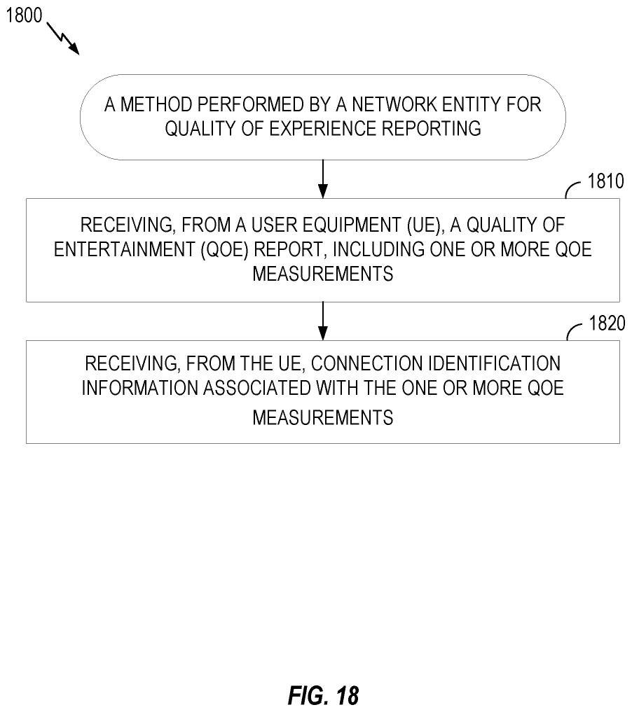

FIG. 18 is a flow diagram illustrating example operations 1800 for wireless communication. The operations 1800 may be performed, for example, by a network entity (e.g., such as the BS 102 in the wireless communication network 100 of FIG. 1 and/or the network entity 702 illustrated in FIGS. 7-16) for receiving QoE reports. The operations 1800 may be complementary to the operations 1700 performed by the UE in FIG. 7. The operations 800 may be implemented as software components that are executed and run on one or more processors (e.g., controller/processor 240 of FIG. 2). Further, the transmission and reception of signals by the BS in operations 1800 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 1800 begin, at 1810, with receiving, from a user equipment (UE), a quality of entertainment (QoE) report, including one or more QoE measurements.

In block 1720, the network entity receives, from the UE, connection identification information associated with the one or more QoE measurements.

In some cases, the connection identification information comprises at least one of: quality of service (QOS) flow identifier associated with the one or more QoE measurements, protocol data unit (PDU) session identifier associated with the one or more QoE measurements, a radio bearer information associated with the one or more QoE measurements, a communication interface associated with the one or more QoE measurements, an access type associated with the one or more QoE measurements, or a cell identifier associated with the one or more QoE measurements.

In some cases, the connection identification information comprises one or more PDU session IDs associated with the one or more QoE measurements.

In some cases, receiving the connection identification information comprises receiving the one or more PDU session IDs within the QoE report, the connection identification information indicating the one or more QoE measurements in the QoE report are associated with one or more PDU sessions identified by the one or more PDU session IDs.

In some cases, the one or more QoE measurements are associated with a subset of PDU sessions of a plurality of PDU session. In some cases, the one or more PDU session IDs include a set of PDU session IDs. In some cases, each different PDU session ID within the set of PDU session IDs corresponds to a different PDU session in the subset of PDU sessions.

In some cases, the connection identification information further comprises one or more QoS flow IDs associated with the one or more QoE measurements.

In some cases, receiving the connection identification information comprises receiving the one or more QoS flow IDs within the QoE report, the connection identification information indicating the one or more QoE measurements in the QoE report are associated with one or more QoS flows identified by the one or more QoS flow IDs.

In some cases, the one or more QoE measurements are associated with a first PDU session. In some cases, the first PDU session includes a plurality of QoS flows. In some cases, the one or more QoE measurements are associated with a subset of QoS flows of the plurality of QoS flows. In some cases, the one or more QoS flow IDs include a set of QoS flow IDs. In some cases, each different QoS flow ID within the set of QoS flow IDs corresponds a different QoS flow in the subset of QoS flows.

In some cases, receiving the connection identification information comprises receiving the one or more PDU session IDs separately from the QoE report, the connection identification information indicating the one or more QoE measurements in the QoE report are associated with one or more PDU sessions identified by the one or more PDU session IDs.

In some cases, receiving the connection identification information comprises receiving the one or more QoS flow IDs separately from the QoE report, the connection identification information indicating the one or more QoE measurements in the QoE report are associated with one or more QoS flows identified by the one or more QoS flow IDs.

In some cases, operations 1800 further include determining, based on at least one of the one or more PDU session IDs or one or more QoS flow IDs, at least one of a radio bearer associated with the one or more QoE measurements or a communication interface associated with the QoE measurements. In some cases, operations 1800 further include sending the QoE report and an indication of at least one of the radio bearer or the communication interface to an operations administration and maintenance (OAM) entity.

In some cases, the connection identification information comprises radio bearer information associated with the one or more QoE measurements. In some cases, the radio bearer information comprises an indication of at least one of: a secondary cell group, a master cell group, a split bearer, or a radio bearer ID.

In some cases, operations 1800 further include transmitting, to the UE, an indication of a mapping between a radio bearers and at least one of one or more PDU session IDs or one or more QoS flow IDs, wherein the radio bearer information is based on the mapping.

In some cases, receiving the connection identification information comprises receiving the radio bearer information separately from the QoE report, the connection identification information indicating the one or more QoE measurements in the QoE report are associated with one or more radio bearers identified by the radio bearer information.

In some cases, receiving the connection identification information comprises receiving the radio bearer information within the QoE report, the connection identification information indicating the one or more QoE measurements in the QoE report are associated with one or more radio bearers identified by the radio bearer information.

In some cases, operations 1800 further include transmitting, to the UE, an indication of at least one a PDU session to perform the one or more QoE measurements for, a QoS flow to perform the one or more QoE measurements for, or a radio bearer to perform the one or more QoE measurements for.

In some cases, the connection identification information comprises an indication of one or more communication interfaces associated with the one or more QoE measurements. In some cases, the one or more communication interfaces comprise at least one of a master node (MN) interface of a dual connectivity configuration or a secondary node (SN) interface of the dual connectivity configuration.

In some cases, operations 1800 further include transmitting, to the UE, an indication of a mapping between the one or more communication interfaces and one or more PDU session IDs. In some cases, the indication of the one or more communication interfaces is based on the mapping.

In some cases, transmitting the indication of the mapping comprises transmitting the indication of the mapping in at least one of: radio resource control (RRC) signaling or non-access stratum signaling.

In some cases, the indication of the one or more communication interfaces is based on a mapping between the one or more communication interfaces and a bearer ID associated with the UE.

In some cases, receiving the connection identification information comprises receiving the indication of the one or more communication interfaces separately from the QoE report, the connection identification information indicating the one or more QoE measurements in the QoE report are associated with one or more communication interfaces identified by indication of the one or more communication interfaces.

In some cases, receiving the connection identification information comprises receiving the indication of the one or more communication interfaces associated with the one or more QoE measurements within the QoE report, the connection identification information indicating the one or more QoE measurements in the QoE report are associated with one or more communication interfaces identified by indication of the one or more communication interfaces.

In some cases, operations 1800 further include transmitting an indication of one or more communication interfaces to perform the one or more QoE measurements for.

In some cases, the connection identification information comprises and indication of a sidelink interface associated with the one or more QoE measurements. In some cases, receiving the connection identification information comprises receiving the indication of the sidelink interface within the QoE report, indicating the one or more QoE measurements in the QoE report are associated with the sidelink interface. In some cases, indication of the sidelink interface is based on one or more rules and the one or more rules comprise a vehicle-to-everything (V2X) rule or a ProSe rule. In some cases, operations 1800 further include transmitting, to the UE, an indication of an application or QoS flow to perform the one or more QoE measurements for on the sidelink interface.

In some cases, the connection identification information comprises and indication of an access type associated with the one or more QoE measurements. In some cases, receiving the connection identification information comprises receiving the indication of the access type within the QoE report, indicating the one or more QoE measurements in the QoE report are associated with the access type. In some cases, indication of the access type is based on one or more rules and the one or more rules comprise an access traffic steering, switching and splitting (ATSSS) rule. In some cases, operations 1800 further include transmitting, to the UE, an indication of an access type to perform the one or more QoE measurements for.

In some cases, the connection identification information comprises cell information associated with the UE. In some cases, receiving the connection identification information comprises receiving the cell information within the QoE report, indicating the one or more QoE measurements in the QoE report are associated with the cell information. In some cases, receiving the connection identification information comprises receiving indication of whether the cell information associated with a QoE measurement in the one or more QoE measurements is the same as a previous QoE measurement transmitted to the network entity.

### Example Wireless Communication Devices

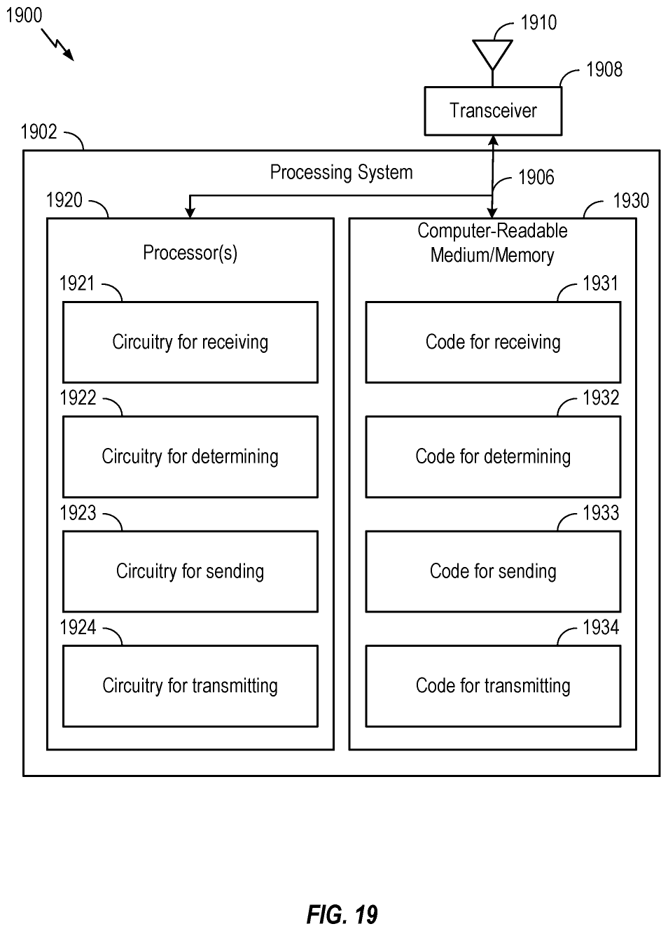

FIG. 19 depicts an example communication device 1900 that includes various components operable, configured, or adapted to perform operations for the techniques disclosed herein, such as the operations depicted and described with respect to FIGS. 7-18. In some examples, communication device 1900 may be a BS 102 as described, for example with respect to FIGS. 1 and 2 and/or a network entity, such as the network entity 702 described with respect to FIGS. 7-16 and 18.

Communications device 1900 includes a processing system 1902 coupled to a transceiver 1908 (e.g., a transmitter and/or a receiver). Transceiver 1908 is configured to transmit (or send) and receive signals for the communications device 1900 via an antenna 1910, such as the various signals as described herein. Processing system 1902 may be configured to perform processing functions for communications device 1900, including processing signals received and/or to be transmitted by communications device 1900.

Processing system 1902 includes one or more processors 1920 coupled to a computer-readable medium/memory 1930 via a bus 1906. In certain aspects, computer-readable medium/memory 1930 is configured to store instructions (e.g., computer-executable code) that when executed by the one or more processors 1920, cause the one or more processors 1920 to perform the operations illustrated in FIGS. 7-16 and 18, or other operations for performing the various techniques discussed herein for receiving QoE reports.

In the depicted example, computer-readable medium/memory 1930 stores code 1931 for receiving, code 1932 for determining, code 1933 for sending, and code 1934 for transmitting.

In the depicted example, the one or more processors 1920 include circuitry configured to implement the code stored in the computer-readable medium/memory 1930, including circuitry 1921 for receiving, circuitry 1922 for determining, and circuitry 1923 for sending, circuitry 1924 for transmitting.

Various components of communications device 1900 may provide means for performing the methods described herein, including with respect to FIGS. 7-16 and 18.

In some examples, means for transmitting or sending (or means for outputting for transmission) may include the transceivers 232 and/or antenna(s) 234 of the network entity 201 illustrated in FIG. 2 and/or transceiver 1908 and antenna 1910 of the communication device 1900 in FIG. 19.

In some examples, means for receiving (or means for obtaining) may include the transceivers 232 and/or antenna(s) 234 of the base station illustrated in FIG. 2 and/or transceiver 1908 and antenna 1910 of the communication device 1900 in FIG. 19.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining may include various processing system components, such as: the one or more processors 1920 in FIG. 19, or aspects of the network entity 201 depicted in FIG. 2, including receive processor 238, transmit processor 220, TX MIMO processor 230, and/or controller/processor 240 (including QoE component 241).

Notably, FIG. 19 is an example, and many other examples and configurations of communication device 1900 are possible.

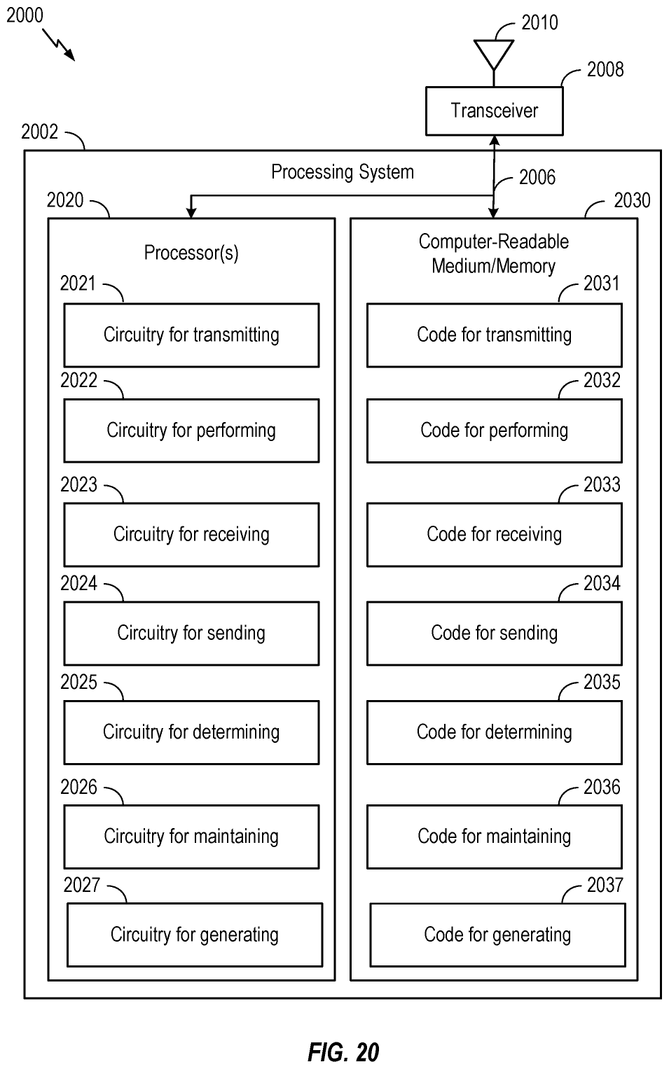

FIG. 20 depicts an example communication device 2000 that includes various components operable, configured, or adapted to perform operations for the techniques disclosed herein, such as the operations depicted and described with respect to FIGS. C-D. In some examples, communication device 2000 may be a user equipment, such as UE 104 as described, for example with respect to FIGS. 1 and 2.

Communications device 2000 includes a processing system 2002 coupled to a transceiver 2008 (e.g., a transmitter and/or a receiver). Transceiver 2008 is configured to transmit (or send) and receive signals for the communications device 2000 via an antenna 2010, such as the various signals as described herein. Processing system 2002 may be configured to perform processing functions for communications device 2000, including processing signals received and/or to be transmitted by communications device 2000.

Processing system 2002 includes one or more processors 2020 coupled to a computer-readable medium/memory 2030 via a bus 2006. In certain aspects, computer-readable medium/memory 2030 is configured to store instructions (e.g., computer-executable code) that when executed by the one or more processors 2020, cause the one or more processors 2020 to perform the operations illustrated in FIGS. 7-16 and 17, or other operations for performing the various techniques discussed herein for QoE reporting.

In the depicted example, computer-readable medium/memory 2030 stores code 2031 for transmitting, code 2032 for performing, code 2033 for receiving, code 2034 for sending, code 2035 for determining, code 2036 for maintaining, and code 2037 for generating.

In the depicted example, the one or more processors 2020 include circuitry configured to implement the code stored in the computer-readable medium/memory 2030, including circuitry 2021 for transmitting, circuitry 2022 for performing, circuitry 2023 for receiving, circuitry 2024 for sending, circuitry 2025 for determining, circuitry 2026 for maintaining, and circuitry 2027 for generating.

Various components of communications device 2000 may provide means for performing the methods described herein, including with respect to FIGS. 7-16 and 17.

In some examples, means for transmitting or sending (or means for outputting for transmission) may include the transceivers 254 and/or antenna(s) 252 of the user equipment 104 illustrated in FIG. 2 and/or transceiver 2008 and antenna 2010 of the communication device 2000 in FIG. 20.

In some examples, means for receiving (or means for obtaining) may include the transceivers 254 and/or antenna(s) 252 of the user equipment 104 illustrated in FIG. 2 and/or transceiver 2008 and antenna 2010 of the communication device 2000 in FIG. 20.

In some examples, means for performing, means for determining, means for maintaining, and means for generating may include various processing system components, such as: the one or more processors 2020 in FIG. 20, or aspects of the user equipment 104 depicted in FIG. 2, including receive processor 258, transmit processor 264, TX MIMO processor 266, and/or controller/processor 280 (including QoE component 281).

Notably, FIG. 20 is an example, and many other examples and configurations of communication device 2000 are possible.

### Example Clauses

Implementation examples are described in the following numbered clauses:

Clause 1: A method for wireless communication performed by a user equipment (UE), comprising: transmitting a quality of entertainment (QoE) report, including one or more QoE measurements, to a network entity; and transmitting, to the network entity, connection identification information associated with the one or more QoE measurements.

Clause 2: The method of Clause 1, wherein the connection identification information comprises at least one of: quality of service (QOS) flow identifier associated with the one or more QoE measurements, protocol data unit (PDU) session identifier associated with the one or more QoE measurements, a radio bearer information associated with the one or more QoE measurements, a communication interface associated with the one or more QoE measurements, an access type associated with the one or more QoE measurements, or a cell identifier associated with the one or more QoE measurements.

Clause 3: The method of any one of Clauses 1-2, further comprising performing the one or more QoE measurements and generating the QoE report in an application layer of the UE.

Clause 4: The method of Clause 3, further comprising receiving, at the application layer of the UE from a non access stratum (NAS) layer of the UE, an indication of one or more protocol data unit (PDU) session IDs, wherein the connection identification information comprises the one or more PDU session IDs.

Clause 5: The method of Clause 4, wherein transmitting the connection identification information to the network entity comprises transmitting the one or more PDU session IDs within the QoE report, indicating the one or more QoE measurements in the QoE report are associated with one or more PDU sessions identified by the one or more PDU session IDs.

Clause 6: The method of Clause 5, wherein: the application layer of the UE includes a plurality of PDU sessions, the one or more QoE measurements are associated with a subset of PDU sessions of the plurality of PDU session, and the one or more PDU session IDs include a set of PDU session IDs, and each different PDU session ID within the set of PDU session IDs corresponds to a different PDU session in the subset of PDU sessions.

Clause 7: The method of any one of Clauses 4-6, further comprising receiving, at the application layer of the UE from the NAS layer of the UE, an indication of one or more a quality of service (QOS) flow identifiers (IDs), wherein the connection identification information further comprises the one or more QoS flow IDs.

Clause 8: The method of Clause 7, wherein transmitting the connection identification information to the network entity comprises transmitting the one or more QoS flow IDs within the QoE report, indicating the one or more QoE measurements in the QoE report are associated with one or more QoS flows identified by the one or more QoS flow IDs.

Clause 9: The method of Clause 8, wherein: the application layer of the UE includes at least a first PDU session, the first PDU session includes a plurality of QoS flows, the one or more QoE measurements are associated with a subset of QoS flows of the plurality of QoS flows, the one or more QoS flow IDs include a set of QoS flow IDs, and each different QoS flow ID within the set of QoS flow IDs corresponds a different QoS flow in the subset of QoS flows.

Clause 10: The method of Clause 4 further comprising: sending the QoE report and the one or more PDU session IDs from the application layer to an access stratum (AS) layer of the UE, wherein: transmitting the QoE report to the network entity comprises transmitting the QoE report to the network entity from the AS layer of the UE, and transmitting the connection identification information to the network entity comprises transmitting, from the AS layer of the UE, the one or more PDU session IDs to the network entity separately from the QoE report, the connection identification information indicating the one or more QoE measurements in the QoE report are associated with one or more PDU sessions identified by the one or more PDU session IDs.

Clause 11: The method of Clause 10, further comprising: receiving, at the application layer of the UE from the NAS layer of the UE, an indication of one or more a quality of service (QOS) flow identifiers (IDs); and sending the one or more QoS flow IDs from the application layer to the AS layer of the UE, wherein transmitting the connection identification information to the network entity further comprises transmitting, from the AS layer of the UE, the one or more QoS flow IDs to the network entity separately from the QoE report, the connection identification information indicating the one or more QoE measurements in the QoE report are associated with one or more QoS flows identified by the one or more QoS flow IDs.

Clause 12: The method of any one of Clauses 3-11, further comprising receiving, at the application layer of the UE from a non access stratum (NAS) layer of the UE, an indication of one or more protocol data unit (PDU) session IDs and one or more a quality of service (QOS) flow identifiers (IDs).

Clause 13: The method of Clause 12, further comprising: sending the one or more PDU session IDs and the one or more QoS flow IDs from the application layer of the UE to an access stratum (AS) layer of the UE; and determining, by the AS layer of the UE, radio bearer information associated with the one or more QoE measurements based on at least one of the one or more PDU session IDs or the one or more QoS flow IDs.

Clause 14: The method of Clause 13, wherein determining the radio bearer information is based on a mapping between radio bearers associated with the UE and at least one of the one or more PDU session IDs or the one or more QoS flow IDs.

Clause 15: The method of any one of Clauses 13-14, wherein the radio bearer information comprises an indication of at least one of: a secondary cell group, a master cell group, a split bearer, or a radio bearer ID.

Clause 16: The method of any one of Clauses 13-15, further comprising sending the QoE report from the application layer of the UE to the AS layer of the UE, wherein: the connection identification information comprises the radio bearer information, transmitting the QoE report to the network entity comprises transmitting the QoE report to the network entity from the AS layer of the UE, and transmitting the connection identification information to the network entity comprises transmitting, from the AS layer of the UE, the radio bearer information to the network entity separately from the QoE report, the connection identification information indicating, the one or more QoE measurements in the QoE report are associated with one or more radio bearers identified by the radio bearer information.

Clause 17: The method of any one of Clauses 13-15, further comprising sending the radio bearer information from the AS layer of the UE to the application layer of the UE, wherein transmitting the connection identification information to the network entity comprises transmitting the radio bearer information within the QoE report, the connection identification information indicating the one or more QoE measurements in the QoE report are associated with one or more radio bearers identified by the radio bearer information.

Clause 18: The method of any one of Clauses 12-17, further comprising receiving, from the network entity, an indication of at least one a PDU session to perform the one or more QoE measurements for, a QoS flow to perform the one or more QoE measurements for, or a radio bearer to perform the one or more QoE measurements for, wherein performing the one or more QoE measurements comprises performing the one or more QoE measurements for the at least one of the indicated PDU session, the indicated QoS flow, or the indicated radio bearer.

Clause 19: The method of any one of Clauses 3-18, further comprising receiving, at the application layer of the UE from a non access stratum (NAS) layer of the UE, an indication of one or more protocol data unit (PDU) session IDs.

Clause 20: The method of Clause 19, further comprising: sending the one or more PDU session IDs from the application layer of the UE to an access stratum (AS) layer of the UE; and determining, by the AS layer of the UE, one or more communication interfaces associated with the one or more QoE measurements based on the one or more PDU session IDs.

Clause 21: The method of Clause 20, wherein the one or more communication interfaces comprise at least one of a master node (MN) interface of a dual connectivity configuration or a secondary node (SN) interface of the dual connectivity configuration.

Clause 22: The method of any one of Clauses 20-21, wherein determining the one or more communication interfaces associated with the one or more QoE measurements is based on a mapping between communication interfaces and the one or more PDU session IDs.

Clause 23: The method of Clause 22, wherein the mapping is received in at least one of: radio resource control (RRC) signaling from the network entity, or NAS signaling from a core network associated with the network entity.

Clause 24: The method of any one of Clauses 20-23, wherein determining the one or more communication interfaces associated with the one or more QoE measurements is based on a mapping between communication interfaces and one or more radio bearer IDs associated with the UE.

Clause 25: The method of any one of Clauses 20-24, further comprising sending the QoE report from the application layer of the UE to the AS layer of the UE, wherein: the connection identification information comprises an indication of the one or more communication interfaces, transmitting the QoE report to the network entity comprises transmitting the QoE report to the network entity from the AS layer of the UE, and transmitting the connection identification information to the network entity comprises transmitting, from the AS layer of the UE, the indication of the one or more communication interfaces to the network entity separately from the QoE report, the connection identification information indicating the one or more QoE measurements in the QoE report are associated with one or more communication interfaces identified by indication of the one or more communication interfaces.

Clause 26: The method of any one of Clauses 20-24, further comprising sending an indication of the one or more communication interfaces associated with the one or more QoE measurements from the AS layer of the UE to the application layer of the UE, wherein: transmitting the connection identification information to the network entity comprises transmitting, from the application layer of the UE, the indication of the one or more communication interfaces associated with the one or more QoE measurements within the QoE report, the connection identification information indicating the one or more QoE measurements in the QoE report are associated with one or more communication interfaces identified by indication of the one or more communication interfaces.

Clause 27: The method of any one of Clauses 19-26, further comprising receiving, from the network entity, an indication of one or more communication interfaces to perform the one or more QoE measurements for, wherein performing the one or more QoE measurements comprises performing the one or more QoE measurements for the indicated one or more communication interfaces.

Clause 28: The method of any one of Clauses 3-27, further comprising determining, by a non-access stratum (NAS) layer of the UE, a sidelink interface is used for at least one of an application associated with the UE or a service flow associated with the UE based on one or more rules.

Clause 29: The method of Clause 28, wherein the one or more rules comprise a vehicle-to-everything (V2X) rule or a ProSe rule.

Clause 30: The method of any one of Clauses 28-29, further comprising sending an indication of the sidelink interface from the NAS layer of the UE to the application layer of the UE, wherein transmitting the connection identification information to the network entity comprises transmitting, from the application layer of the UE, the indication of the sidelink interface within the QoE report, indicating the one or more QoE measurements in the QoE report are associated with the sidelink interface.

Clause 31: The method of any one of Clauses 3-20, further comprising determining, by a non-access stratum (NAS) layer of the UE, an access type used for at least one of an application associated with the UE or a service flow associated with the UE based on one or more rules.

Clause 32: The method of Clause 31, wherein the one or more rules comprise an access traffic steering, switching and splitting (ATSSS) rule.

Clause 33: The method of any one of Clauses 31-32, further comprising sending an indication of the access type from the NAS layer of the UE to the application layer of the UE, wherein transmitting the connection identification information to the network entity comprises transmitting, from the application layer of the UE, the indication of the access type within the QoE report, indicating the one or more QoE measurements in the QoE report are associated with the access type.

Clause 34: The method of any one of Clauses 3-33, further comprising sending, from an access stratum (AS) layer of the UE to the application layer of the UE, cell information associated with the UE.

Clause 35: The method of Clause 34, wherein sending the cell information to the application layer comprises sending the cell information to the application layer when at least one of: the UE enters an idle state or an inactive state, or the cell information associated with the UE changes.

Clause 36: The method of any one of Clauses 34-34, wherein transmitting the connection identification information to the network entity comprises transmitting the cell information within the QoE report, indicating the one or more QoE measurements in the QoE report are associated with the cell information.

Clause 37: The method of any one of Clauses 3-36, further comprising: sending, from the application layer of the UE to an access stratum (AS) layer of the UE, the QoE report including the one or more QoE measurements; and sending, from the application layer of the UE to the AS layer of the UE, timestamp information for each QoE measurement of the one or more QoE measurements in the QoE report.

Clause 38: The method of Clause 37, further comprising: maintaining, by the AS layer of the UE, a cell history list including a plurality of cells and corresponding timestamps; and determining cell information associated with the one or more QoE measurements in the QoE report based on the cell history list and the timestamp information for each QoE measurement of the one or more QoE measurements.

Clause 39: The method of Clause 38, wherein: transmitting the QoE report to the network entity comprises transmitting the QoE report to the network entity from the AS layer of the UE, and transmitting the connection identification information to the network entity comprises transmitting, from the AS layer of the UE, the cell information separately from the QoE report, the connection identification information indicating the one or more QoE measurements in the QoE report are associated with the cell information.

Clause 40: The method of Clause 39, wherein transmitting the connection identification information to the network entity comprises transmitting, from the AS layer of the UE, an indication of whether the cell information associated with a QoE measurement in the one or more QoE measurements is the same as a previous QoE measurement transmitted to the network entity.

Clause 41: A method for wireless communication performed by a network entity, comprising: receiving, from a user equipment (UE), a quality of entertainment (QoE) report, including one or more QoE measurements; and receiving, from the UE, connection identification information associated with the one or more QoE measurements.

Clause 42: The method of Clause 41, wherein the connection identification information comprises at least one of: quality of service (QOS) flow identifier associated with the one or more QoE measurements, protocol data unit (PDU) session identifier associated with the one or more QoE measurements, a radio bearer information associated with the one or more QoE measurements, a communication interface associated with the one or more QoE measurements, an access type associated with the one or more QoE measurements, or a cell identifier associated with the one or more QoE measurements.

Clause 43: The method of any one of Clauses 41-42, wherein the connection identification information comprises one or more PDU session IDs associated with the one or more QoE measurements.

Clause 44: The method of Clause 43, wherein receiving the connection identification information comprises receiving the one or more PDU session IDs within the QoE report, the connection identification information indicating the one or more QoE measurements in the QoE report are associated with one or more PDU sessions identified by the one or more PDU session IDs.

Clause 45: The method of any one of Clauses 43-44, wherein: the one or more QoE measurements are associated with a subset of PDU sessions of a plurality of PDU session, and the one or more PDU session IDs include a set of PDU session IDs, and each different PDU session ID within the set of PDU session IDs corresponds to a different PDU session in the subset of PDU sessions.

Clause 46: The method of any one of Clauses 43-45, wherein the connection identification information further comprises one or more QoS flow IDs associated with the one or more QoE measurements.

Clause 47: The method of Clause 46, wherein receiving the connection identification information comprises receiving the one or more QoS flow IDs within the QoE report, the connection identification information indicating the one or more QoE measurements in the QoE report are associated with one or more QoS flows identified by the one or more QoS flow IDs.

Clause 48: The method of any one of Clauses 46-47, wherein: the one or more QoE measurements are associated with a first PDU session, the first PDU session includes a plurality of QoS flows, the one or more QoE measurements are associated with a subset of QoS flows of the plurality of QoS flows, the one or more QoS flow IDs include a set of QoS flow IDs, and each different QoS flow ID within the set of QoS flow IDs corresponds a different QoS flow in the subset of QoS flows.

Clause 49: The method of Clause 46 wherein receiving the connection identification information comprises receiving the one or more PDU session IDs separately from the QoE report, the connection identification information indicating the one or more QoE measurements in the QoE report are associated with one or more PDU sessions identified by the one or more PDU session IDs.

Clause 50: The method of any one of Clauses 46 or 49, wherein receiving the connection identification information comprises receiving the one or more QoS flow IDs separately from the QoE report, the connection identification information indicating the one or more QoE measurements in the QoE report are associated with one or more QoS flows identified by the one or more QoS flow IDs.

Clause 51: The method of any one of Clauses 46-50, further comprising: determining, based on at least one of the one or more PDU session IDs or one or more QoS flow IDs, at least one of a radio bearer associated with the one or more QoE measurements or a communication interface associated with the QoE measurements; and sending the QoE report and an indication of at least one of the radio bearer or the communication interface to an operations administration and maintenance (OAM) entity.

Clause 52: The method of any one of Clauses 41-51, wherein the connection identification information comprises radio bearer information associated with the one or more QoE measurements.

Clause 53: The method of Clause 52, further comprising transmitting, to the UE, an indication of a mapping between a radio bearers and at least one of one or more PDU session IDs or one or more QoS flow IDs, wherein the radio bearer information is based on the mapping.

Clause 54: The method of any one of Clauses 52-53, wherein the radio bearer information comprises an indication of at least one of: a secondary cell group, a master cell group, a split bearer, or a radio bearer ID.

Clause 55: The method of any one of Clauses 52-54, wherein receiving the connection identification information comprises receiving the radio bearer information separately from the QoE report, the connection identification information indicating the one or more QoE measurements in the QoE report are associated with one or more radio bearers identified by the radio bearer information.

Clause 56: The method of any one of Clauses 52-54, wherein receiving the connection identification information comprises receiving the radio bearer information within the QoE report, the connection identification information indicating the one or more QoE measurements in the QoE report are associated with one or more radio bearers identified by the radio bearer information.

Clause 57: The method of any one of Clauses 52-56, further comprising transmitting, to the UE, an indication of at least one a PDU session to perform the one or more QoE measurements for, a QoS flow to perform the one or more QoE measurements for, or a radio bearer to perform the one or more QoE measurements for.

Clause 58: The method of any one of Clauses 41-57, wherein the connection identification information comprises an indication of one or more communication interfaces associated with the one or more QoE measurements.

Clause 59: The method of Clause 58, wherein the one or more communication interfaces comprise at least one of a master node (MN) interface of a dual connectivity configuration or a secondary node (SN) interface of the dual connectivity configuration.

Clause 60: The method of any one of Clauses 58-59, further comprising transmitting, to the UE, an indication of a mapping between the one or more communication interfaces and one or more PDU session IDs, wherein the indication of the one or more communication interfaces is based on the mapping.

Clause 61: The method of Clause 60, wherein transmitting the indication of the mapping comprises transmitting the indication of the mapping in at least one of: radio resource control (RRC) signaling, or non-access stratum signaling.

Clause 62: The method of any one of Clauses 58-61, wherein the indication of the one or more communication interfaces is based on a mapping between the one or more communication interfaces and a bearer ID associated with the UE.

Clause 63: The method of any one of Clauses 58-62, wherein receiving the connection identification information comprises receiving the indication of the one or more communication interfaces separately from the QoE report, the connection identification information indicating the one or more QoE measurements in the QoE report are associated with one or more communication interfaces identified by indication of the one or more communication interfaces.

Clause 64: The method of any one of Clauses 58-62, wherein receiving the connection identification information comprises receiving the indication of the one or more communication interfaces associated with the one or more QoE measurements within the QoE report, the connection identification information indicating the one or more QoE measurements in the QoE report are associated with one or more communication interfaces identified by indication of the one or more communication interfaces.

Clause 65: The method of any one of Clauses 58-64, further comprising transmitting an indication of one or more communication interfaces to perform the one or more QoE measurements for.

Clause 66: The method of any one of Clauses 41-65, wherein: the connection identification information comprises and indication of a sidelink interface associated with the one or more QoE measurements, and receiving the connection identification information comprises receiving the indication of the sidelink interface within the QoE report, indicating the one or more QoE measurements in the QoE report are associated with the sidelink interface.

Clause 67: The method of Clause 66, wherein indication of the sidelink interface is based on one or more rules and the one or more rules comprise a vehicle-to-everything (V2X) rule or a ProSe rule.

Clause 68: The method of any one of Clauses 66-67, further comprising transmitting, to the UE, an indication of an application or service flow to perform the one or more QoE measurements for on the sidelink interface.

Clause 69: The method of any one of Clauses 41-68, wherein: the connection identification information comprises and indication of an access type associated with the one or more QoE measurements, and receiving the connection identification information comprises receiving the indication of the access type within the QoE report, indicating the one or more QoE measurements in the QoE report are associated with the access type.

Clause 70: The method of Clause 69, wherein indication of the access type is based on one or more rules and the one or more rules comprise an access traffic steering, switching and splitting (ATSSS) rule.

Clause 71: The method of any one of Clauses 69-70, further comprising transmitting, to the UE, an indication of an access type to perform the one or more QoE measurements for.

Clause 72: The method of any one of Clauses 41-71, wherein the connection identification information comprises cell information associated with the UE.

Clause 73: The method of Clause 72, wherein receiving the connection identification information comprises receiving the cell information within the QoE report, indicating the one or more QoE measurements in the QoE report are associated with the cell information.

Clause 74: The method of Clause 73, wherein receiving the connection identification information comprises receiving indication of whether the cell information associated with a QoE measurement in the one or more QoE measurements is the same as a previous QoE measurement transmitted to the network entity.

Clause 75: An apparatus, comprising: a memory comprising executable instructions; and one or more processors configured to execute the executable instructions and cause the apparatus to perform a method in accordance with any one of Clauses 1-74.

Clause 76: An apparatus, comprising means for performing a method in accordance with any one of Clauses 1-74.

Clause 77: A non-transitory computer-readable medium comprising executable instructions that, when executed by one or more processors of an apparatus, cause the apparatus to perform a method in accordance with any one of Clauses 1-74.

Clause 78: A computer program product embodied on a computer-readable storage medium comprising code for performing a method in accordance with any one of Clauses 1-74.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., a gNB) may operate in a traditional sub-6 GHz spectrum, in millimeter wave (mmWave) frequencies, and/or near mmWave frequencies in communication with the UE 104. When the BS 180 operates in mm Wave or near mm Wave frequencies, the BS 180 may be referred to as an mm Wave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of network entity 201 and UE 104 (e.g., the wireless communication network 100 of FIG. 1) are depicted, which may be used to implement aspects of the present disclosure.

At network entity 201, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the network entity 201 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to network entity 201.

At network entity 201, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for network entity 201 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ×15} kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of QoE reporting enhancements in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE), comprising:
one or more memories comprising executable instructions; and
one or more processors configured to execute the executable instructions and to cause the UE to:
transmit a quality of entertainment (QoE) report, including one or more QoE measurements, to a network entity; and
transmit, to the network entity, connection identification information associated with the one or more QoE measurements.

2. The UE of claim 1, wherein the connection identification information comprises at least one of:
quality of service (QOS) flow identifier associated with the one or more QoE measurements,
protocol data unit (PDU) session identifier associated with the one or more QoE measurements,
a radio bearer information associated with the one or more QoE measurements,
a communication interface associated with the one or more QoE measurements,
an access type associated with the one or more QoE measurements, or
a cell identifier associated with the one or more QoE measurements.

3. The UE of claim 1, wherein the one or more processors are further configured to cause the UE to perform the one or more QoE measurements and generate the QoE report in an application layer of the UE.

4. The UE of claim 3, wherein:
the one or more processors are further configured to cause the UE to receive, at the application layer of the UE from a non access stratum (NAS) layer of the UE, an indication of one or more protocol data unit (PDU) session IDs, and
the connection identification information comprises the one or more PDU session IDs.

5. The UE of claim 4, wherein, in order to transmit the connection identification information to the network entity, the one or more processors are configured to cause the UE to transmit the one or more PDU session IDs within the QoE report, indicating the one or more QoE measurements in the QoE report are associated with one or more PDU sessions identified by the one or more PDU session IDs.

6. The UE of claim 5, wherein:
the application layer of the UE includes a plurality of PDU sessions,
the one or more QoE measurements are associated with a subset of PDU sessions of the plurality of PDU session, and
the one or more PDU session IDs include a set of PDU session IDs, and
each different PDU session ID within the set of PDU session IDs corresponds to a different PDU session in the subset of PDU sessions.

7. The UE of claim 4, further wherein:
the one or more processors are further configured to cause the UE to receive, at the application layer of the UE from the NAS layer of the UE, an indication of one or more a quality of service (QOS) flow identifiers (IDs),
the connection identification information further comprises the one or more QoS flow IDs, and
in order to transmit the connection identification information to the network entity, the one or more processors are configured to cause the UE to transmit the one or more QoS flow IDs within the QoE report, indicating the one or more QoE measurements in the QoE report are associated with one or more QoS flows identified by the one or more QoS flow IDs.

8. The UE of claim 7, wherein:
the application layer of the UE includes at least a first PDU session,
the first PDU session includes a plurality of QoS flows,
the one or more QoE measurements are associated with a subset of QoS flows of the plurality of QoS flows,
the one or more QoS flow IDs include a set of QoS flow IDs, and
each different QoS flow ID within the set of QoS flow IDs corresponds a different QoS flow in the subset of QoS flows.

9. The UE of claim 4, wherein:
the one or more processors are further configured to cause the UE to:
receive, at the application layer of the UE from the NAS layer of the UE, an indication of one or more a quality of service (QOS) flow identifiers (IDs)
send the QoE report, the one or more PDU session IDs, and the one or more QoS flow IDs from the application layer to an access stratum (AS) layer of the UE, wherein:
in order to transmit the QoE report to the network entity, the one or more processors are configured to cause the UE to transmit the QoE report to the network entity from the AS layer of the UE,
in order to transmit the connection identification information to the network entity, the one or more processors are configured to cause the UE to transmit, from the AS layer of the UE, at least one of the one or more PDU session IDs or the one or more QoS flow IDs to the network entity separately from the QoE report, and
the connection identification information indicates the one or more QoE measurements in the QoE report are associated with one or more PDU sessions identified by the one or more PDU session IDs.

10. The UE of claim 3, wherein the one or more processors are further configured to cause the UE to receive, at the application layer of the UE from a non access stratum (NAS) layer of the UE, an indication of one or more protocol data unit (PDU) session IDs associated with the UE and one or more a quality of service (QOS) flow identifiers (IDs) associated with the UE.

11. The UE of claim 10, wherein:
the one or more processors are further configured to cause the UE to:
send the one or more PDU session IDs and the one or more QoS flow IDs from the application layer of the UE to an access stratum (AS) layer of the UE; and
determine, by the AS layer of the UE, radio bearer information associated with the UE based on at least one of the one or more PDU session IDs or the one or more QoS flow IDs, and
the radio bearer information comprises an indication of at least one of:
a secondary cell group,
a master cell group,
a split bearer, or
a radio bearer ID.

12. The UE of claim 11, wherein the one or more processors are configured to cause the UE to determine the radio bearer information based on a mapping between radio bearers associated with the UE and at least one of the one or more PDU session IDs or the one or more QoS flow IDs.

13. The UE of claim 11, wherein:
the one or more processors are further configured to cause the UE to send the QoE report from the application layer of the UE to the AS layer of the UE,
the connection identification information comprises the radio bearer information,
in order to transmit the QoE report to the network entity, the one or more processors are configured to cause the UE to transmit the QoE report to the network entity from the AS layer of the UE,
in order to transmit the connection identification information to the network entity, the one or more processors are configured to cause the UE to transmit, from the AS layer of the UE, the radio bearer information to the network entity separately from the QoE report, and
the connection identification information indicates, the one or more QoE measurements in the QoE report are associated with one or more radio bearers identified by the radio bearer information.

14. The UE of claim 11, wherein:
the one or more processors are further configured to cause the UE to send the radio bearer information from the AS layer of the UE to the application layer of the UE,
in order to transmit the connection identification information to the network entity, the one or more processors are configured to cause the UE to transmit the radio bearer information within the QoE report, and
the connection identification information indicates the one or more QoE measurements in the QoE report are associated with one or more radio bearers identified by the radio bearer information.

15. The UE of claim 10, wherein:
wherein the one or more processors are further configured to cause the UE to receive, from the network entity, an indication of at least one a PDU session to perform the one or more QoE measurements for, a QoS flow to perform the one or more QoE measurements for, or a radio bearer to perform the one or more QoE measurements for, and
in order to perform the one or more QoE measurements, the one or more processors are configured to cause the UE to perform the one or more QoE measurements for the at least one of the indicated PDU session, the indicated QoS flow, or the indicated radio bearer.

16. The UE of claim 3, wherein the one or more processors are further configured to cause the UE to:
receive, at the application layer of the UE from a non access stratum (NAS) layer of the UE, an indication of one or more protocol data unit (PDU) session IDs;
send the one or more PDU session IDs from the application layer of the UE to an access stratum (AS) layer of the UE; and
determine, by the AS layer of the UE, one or more communication interfaces associated with the UE based on the one or more PDU session IDs.

17. The UE of claim 16, wherein the one or more communication interfaces comprise at least one of a master node (MN) interface of a dual connectivity configuration or a secondary node (SN) interface of the dual connectivity configuration.

18. The UE of claim 16, wherein:
one or more processors are configured to cause the UE to determine the one or more communication interfaces associated with the UE based on a mapping between communication interfaces and the one or more PDU session IDs, and
the mapping is received in at least one of:
radio resource control (RRC) signaling from the network entity, or
NAS signaling from a core network associated with the network entity.

19. The UE of claim 16, the one or more processors are configured to cause the UE to determine the one or more communication interfaces associated with the UE based on a mapping between communication interfaces and one or more radio bearer IDs associated with the UE.

20. The UE of claim 16, wherein:
the one or more processors are further configured to cause the UE to send the QoE report from the application layer of the UE to the AS layer of the UE,
the connection identification information comprises an indication of the one or more communication interfaces,
in order to transmit the QoE report to the network entity, the one or more processors are configured to cause the UE to transmit the QoE report to the network entity from the AS layer of the UE,
in order to transmit the connection identification information to the network entity, the one or more processors are configured to cause the UE to transmit, from the AS layer of the UE, the indication of the one or more communication interfaces to the network entity separately from the QoE report, and
the connection identification information indicates the one or more QoE measurements in the QoE report are associated with one or more communication interfaces identified by indication of the one or more communication interfaces.

21. The UE of claim 16, wherein:
the one or more processors are further configured to cause the UE to send an indication of the one or more communication interfaces from the AS layer of the UE to the application layer of the UE,
in order to transmit the connection identification information to the network entity, the one or more processors are configured to cause the UE to transmit, from the application layer of the UE, the indication of the one or more communication interfaces within the QoE report, and
the connection identification information indicates the one or more QoE measurements in the QoE report are associated with one or more communication interfaces identified by indication of the one or more communication interfaces.

22. The UE of claim 16, wherein:
the one or more processors are further configured to cause the UE to receive, from the network entity, an indication of one or more communication interfaces to perform the one or more QoE measurements for, and
in order to perform the one or more QoE measurements, the one or more processors are configured to cause the UE to perform the one or more QoE measurements for the indicated one or more communication interfaces.

23. The UE of claim 3, wherein:
the one or more processors are further configured to cause the UE to determine, by a non-access stratum (NAS) layer of the UE, a sidelink interface is used for at least one of an application associated with the UE or a service flow associated with the UE based on one or more rules,
the one or more rules comprise a vehicle-to-everything (V2X) rule or a ProSe rule,
the one or more processors are further configured to cause the UE to send an indication of the sidelink interface from the NAS layer of the UE to the application layer of the UE, and
in order to transmit the connection identification information to the network entity, the one or more processors are configured to cause the UE to transmit, from the application layer of the UE, the indication of the sidelink interface within the QoE report, indicating the one or more QoE measurements in the QoE report are associated with the sidelink interface.

24. The UE of claim 3, wherein:
the one or more processors are further configured to cause the UE to determine, by a non-access stratum (NAS) layer of the UE, an access type used for at least one of an application associated with the UE or a service flow associated with the UE based on one or more rules,
the one or more rules comprise an access traffic steering, switching and splitting (ATSSS),
the one or more processors are further configured to cause the UE to send an indication of the access type from the NAS layer of the UE to the application layer of the UE, and
in order to transmit the connection identification information to the network entity, the one or more processors are configured to cause the UE to transmit, from the application layer of the UE, the indication of the access type within the QoE report, indicating the one or more QoE measurements in the QoE report are associated with the access type.

25. The UE of claim 3, wherein:
the one or more processors are further configured to cause the UE to send, from an access stratum (AS) layer of the UE to the application layer of the UE, cell information associated with the UE,
in order to send the cell information to the application layer, the one or more processors are configured to cause the UE to send the cell information to the application layer when at least one of:
the UE enters an idle state or an inactive state, or
the cell information associated with the UE changes, and
in order to transmit the connection identification information to the network entity, the one or more processors are configured to cause the UE to transmit the cell information within the QoE report, indicating the one or more QoE measurements in the QoE report are associated with the cell information.

26. The UE of claim 3, wherein the one or more processors are further configured to cause the UE to:
send, from the application layer of the UE to an access stratum (AS) layer of the UE, the QoE report including the one or more QoE measurements;
send, from the application layer of the UE to the AS layer of the UE, timestamp information for each QoE measurement of the one or more QoE measurements in the QoE report;
maintain, by the AS layer of the UE, a cell history list including a plurality of cells and corresponding timestamps; and
determine cell information associated with the one or more QoE measurements in the QoE report based on the cell history list and the timestamp information for each QoE measurement of the one or more QoE measurements.

27. The UE of claim 26, wherein:
in order to transmit the QoE report to the network entity, the one or more processors are further configured to cause the UE to transmit the QoE report to the network entity from the AS layer of the UE, and
in order to transmit the connection identification information to the network entity, the one or more processors are configured to cause the UE to at least one of
transmit, from the AS layer of the UE, the cell information separately from the QoE report, the connection identification information indicating the one or more QoE measurements in the QoE report are associated with the cell information, or
transmit, from the AS layer of the UE, an indication of whether the cell information associated with a QoE measurement in the one or more QoE measurements is the same as a previous QoE measurement transmitted to the network entity.

28. A method for wireless communication by a user equipment (UE), comprising:
transmitting a quality of entertainment (QoE) report, including one or more QoE measurements, to a network entity; and
transmitting, to the network entity, connection identification information associated with the one or more QoE measurements.

29. (canceled)

30. (canceled)
